(19) United States
(12) Patent Application Publication
(10) Pub. No.: US 2012/0123637 A1
(43) Pub. Date: May 17, 2012

(54) SPECTRUM MEASURING APPARATUS FOR MOVER

(75) Inventors: Ryuji Funayama, Yokohama-shi (JP); Shinya Kawamata, Gotemba-shi (JP); Masato Endo, Susono-shi (JP); Yasukata Yokochi, Susono-shi (JP); Yasuhiro Yoshida, Susono-shi (JP); Kenichi Kitahama, Nagoya-shi (JP)

(73) Assignee: TOYOTA JIDOSHA KABUSHIKI KAISHA, Toyota-shi (JP)

(21) Appl. No.: 13/322,508

(22) PCT Filed: May 29, 2009
(86) PCT No.: PCT/JP2009/059914

§ 371 Date: Jan. 20, 2012

(51) Int. Cl. G06F 7/00; G01J 3/28

(52) U.S. Cl. 701/36; 356/326

(57) ABSTRACT

Disclosed is a mover spectrum measuring apparatus, which is able to discriminate an object being measured more reliably by relieving the influences of an environmental light on photographic data by a spectrum sensor mounted on a mover such as a vehicle. A spectrum sensor capable of measuring wavelength information and optical intensity information is mounted on a vehicle, so that an object being measured around the vehicle is discriminated on the basis of the spectrum data relating to the observation light detected by the spectrum sensor. The mover spectrum measuring apparatus comprises an illumination device for making variable the featuring quantity of at least either the wavelength range of the observation light or the optical intensity of each wavelength, and controls the featuring quantity varying mode by the illumination device through an illumination controller on the basis of the control value according to an environmental element.

### TECHNICAL FIELD

The present invention relates to a movable body spectrum measuring apparatus for discriminating a measuring object on the basis of spectrum data regarding the measuring object as measured by a spectrum sensor mounted on a movable body such as a vehicle, in particular, an automobile.

### BACKGROUND ART

In recent years, vehicles such as automobiles have been often provided with a drive assisting device that recognizes the state of a pedestrian, a traffic light or the like, which dynamically varies around the vehicle, and assists driving and decision making for the driver. Most of such apparatuses take an image of the state of a traffic light, a pedestrian or the like by use of a CCD camera, processes the taken image in real time to recognize the state and uses the recognition result for the above-mentioned assistance for driving. However, since the shape of a pedestrian generally varies depending on size, orientation or presence or absence of his/her belongings, it is difficult to correctly recognize the existence of a pedestrian on the basis of the shape obtained by the above-mentioned image processing. Although traffic lights are highly standardized in size and color, the shapes disadvantageously vary depending on the viewing angle, and shape recognition through the above-mentioned image processing has its limits.

Patent Document 1 describes a remote sensing technique using spectrum data collected by a spectrum sensor as one technique for recognizing a measuring object. According to this technique, measuring objects such as woods, agricultural fields and urban areas, which are difficult to be recognized only by a visible light region, are discriminated by classifying and characterizing multi-spectrum image data also including invisible light regions photographed by the spectrum sensor mounted on an airplane, an artificial satellite, or the like.

### PRIOR ART DOCUMENTS

### Patent Documents

Patent Document 1: Japanese Laid-Open Patent Publication No. 2000-251052
Patent Document 2: Japanese Laid-Open Patent Publication No. 2006-145362

### DISCLOSURE OF THE INVENTION

### Problems to be Solved by the Invention

Since a spectrum sensor observes a brightness value (light intensity) of each wavelength range also including the invisible light region, characteristics of the measuring object can be found by comparing brightness values of wavelengths with each other and furthermore, allowing the measuring object to be discriminated. In addition, in recent years, a hyper spectrum sensor having a wide imageable bandwidth and a high resolution of a few nm to a dozens of nm has been put into practical use as the above-mentioned spectrum sensor (refer to Patent Document 2).

Thus, it has been recently considered that such a spectrum sensor mounted on a vehicle such as an automobile, and various measuring objects around the vehicle are discriminated on the basis of spectrum data taken by the spectrum sensor. However, in the case where such a spectrum sensor is applied to a movable body such as a vehicle, the spectrum of even an identical measuring object varies due to the influence of ambient light, including weather and the degree of sunshine, the brightness of street lamps, and road environment. For this reason, even when spectrum data regarding the measuring object is acquired by the spectrum sensor, lowering of recognition accuracy due to such influences from ambient light is inevitable.

Accordingly, it is an objective of the present invention to provide a movable body spectrum measuring apparatus that reduces the influence of ambient light on data captured by the spectrum sensor mounted on a movable body such as a vehicle, thereby enabling discrimination of a measuring object with higher reliability.

### Means for Solving the Problems

To achieve the foregoing objective, a movable body spectrum measuring apparatus according to the present invention is provided with a spectrum sensor mounted on a movable body. The spectrum sensor is capable of measuring wavelength information and light intensity information. The spectrum measuring apparatus discriminates a measuring object around the movable body on the basis of spectrum data regarding observation light detected by the spectrum sensor. The apparatus includes a feature value varying device and a controller. The feature value varying device varies a feature value of at least one of a wavelength range of the observation light and a light intensity at each wavelength of the observation light. The controller controls a feature value varying mode of the feature value varying device on the basis of a control value corresponding to an environment element.

As with the above-mentioned configuration, if the feature value varying device varies the feature value of at least one of the wavelength range and the light intensity at each wavelength of the observation light, which is detected by the spectrum sensor, according to the environment element at each time, for example, even when the ambient light varies, the wavelength range and the light intensity at each wavelength of the observation light can be adequately compensated for so as to reduce the influence from ambient light. Thereby, in discriminating the measuring object on the basis of detection of the observation light, the discrimination can be achieved with high accuracy.

According to one aspect of the present invention, an illumination device is provided as the feature value varying device. The illumination device radiates reference light. At least one of the wavelength range and the light intensity at each wavelength of the reference light is changeable. The controller controls at least one of the wavelength range and the light intensity at each wavelength of the reference light radiated from the illumination device on the basis of the control value, thereby varying the feature value of the observation light.

With the above-mentioned configuration, by adjusting at least one of the wavelength range and the light intensity at each wavelength of the reference light radiated toward the measuring object, the wavelength range and the light intensity at each wavelength of light reflected from the measuring object irradiated with the reference light, that is, the feature value of the observation light detected by the spectrum sensor can be adjusted. For this reason, in discriminating the measuring object on the basis of the spectrum data detected by the spectrum sensor, the spectrum data corresponding to the ambient light radiated toward the measuring object can be acquired, resulting in that discrimination on the attribute and the like of the measuring object can be achieved with high accuracy.

In accordance with one aspect of the present invention, the controller is configured to be capable of controlling blinking of reference light radiated from the illumination device.

With the above-mentioned configuration, by blinking of the reference light radiated toward the measuring object, each of the spectrum data during radiation of the reference light and the spectrum data during non-radiation of the reference light can be acquired. For this reason, the measuring object can be discriminated on the basis of each of the spectrum data regarding the measuring object that is irradiated with the reference light and the spectrum data regarding the measuring object that is not irradiated with the reference light.

In accordance with one aspect of the present invention, an illumination device is provided as the feature value varying device. The illumination device radiates reference light toward the measuring object. The controller controls blinking of the reference light radiated from the illumination device on the basis of the control value, thereby varying the feature value of the observation light.

With the above-mentioned configuration, by blinking the reference light radiated toward the measuring object, for example, at predetermined cycles, the spectrum data during radiation of the reference light and the spectrum data during non-radiation of the reference light can be acquired in real time. Thus, the measuring object can be discriminated on the basis of each of the spectrum data regarding the measuring object that is irradiated with the reference light and the spectrum data regarding the measuring object that is not irradiated with the reference light. Further, by controlling blinking the reference light, the wavelength range and the light intensity at each wavelength of light reflected from the measuring object irradiated with the reference light, that is, the feature value of the observation light detected by the spectrum sensor can be also adjusted. Thereby, in discriminating the measuring object on the basis of the spectrum data detected by the spectrum sensor, the spectrum data corresponding to the ambient light radiated toward the measuring object can be acquired, resulting in that discrimination on the attribute and the like of the measuring object can be achieved with high accuracy.

In accordance with one aspect of the present invention, the measuring object is discriminated by computing the spectrum data during radiation of the reference light and the spectrum data during non-radiation of the reference light on the basis of control of blinking of the reference light by the controller.

For the spectrum data regarding the measuring object that is irradiated with the reference light and the spectrum data regarding the measuring object that is not irradiated with the reference light, which are acquired through control of the above-mentioned blinking, a difference between the pieces of spectrum data regarding objects other than the light source such as a self-luminous body becomes remarkable. Then, as with the above-mentioned configuration, the measuring object can be easily discriminated on the basis of the computation of each of the spectrum data regarding the measuring object that is irradiated with the reference light and the spectrum data regarding the measuring object that is not irradiated with the reference light.

In accordance with one aspect of the present invention, in computing the two pieces of spectrum data regarding the observation light, the difference or the ratio between the pieces of spectrum data is acquired.

As with the above-mentioned configuration, by discriminating the measuring object based on the difference or the ratio between the spectrum data during radiation of the reference light and the spectrum data during non-radiation of the reference light, which are acquired during blinking of the reference light, it becomes possible to further reduce and suppress the influence of the ambient light such as electric light and sunlight, which is radiated toward the measuring object, separately from the reference light radiated from the illumination device. Thereby, in discriminating the measuring object on the basis of such detection of the spectrum data, the measuring object can be discriminated with higher accuracy.

In accordance with one aspect of the present invention, the discrimination of the measuring object is discrimination on whether or not the measuring object is a self-luminous body on the basis of a differential computation between the pieces of the spectrum data regarding the observation light.

For example, when the reference light is radiated from the illumination device to a reflector having a high reflectance, reference light reflected once by the reflector is detected as the observation light by the spectrum sensor. Meanwhile, since the reflector itself does not emit light during non-radiation of the reference light, light reflected from ambient light or the like is detected as the observation light by the spectrum sensor. For this reason, when an object irradiated with the reference light is a reflector, the difference between the spectrum data during radiation of the reference light and the spectrum data during non-radiation of the reference light becomes large.

When the reference light is radiated from the illumination device to a self-luminous body, light emitted from the self-luminous body and the reference light radiated from the illumination device are detected by the wavelength sensor. Meanwhile, during non-radiation of the reference light, the light emitted from the self-luminous body and the ambient light are detected by the spectrum sensor. For this reason, when the object irradiated with the reference light is a reflector, the difference between the spectrum data during radiation of the reference light and the spectrum data during non-radiation of the reference light is reduced by the light emitted from the self-luminous body.

By discriminating the measuring object on the basis of the difference between the spectrum data during radiation of the reference light and the spectrum data during non-radiation of the reference light in this manner, it is possible to determine whether or not the measuring object is a self-luminous body, or whether or not the measuring object is a reflector.

In accordance with one aspect of the present invention, ambient light of the measuring object is light from an electric lamp lit with power supplied from a commercial AC power source. A blinking cycle of the blinking control of the reference light by the controller is set so as to be in sync with a cycle using an AC frequency of the commercial AC power source as a reference.

A light-emitting basic cycle of an electric lamp such as a fluorescent lamp lit with power supplied from a commercial AC power source is, for example in Japan, a “100 Hz standard” in the Kanto area and a “120 Hz standard” in the Kansai area. As with the above-mentioned configuration, when the ambient light is from an electric lamp, by blinking the reference light in sync with the light-emitting basic cycle, influence from the ambient light due to radiation of the reference light can be reliably eliminated.

In accordance with one aspect of the present invention, the movable body is provided with a drive assistance system for periodically computing various information supporting driving of the movable body. A blinking cycle of the blinking control of the reference light by the controller is set so as to be equal to or smaller than a computation cycle of the drive assistance system.

When the movable body is an automobile, the computation cycle of the drive assistance system (microcomputer) is, for example, “100 msec”. As with the above-mentioned configuration, by setting the blinking cycle of the reference light so as to be equal to or smaller than the computation cycle of the drive assistance system, the measuring object can be monitored in real time and reliability of drive assistance of the movable body on the basis of discrimination of the monitored measuring object can be improved.

In accordance with one aspect of the present invention, the illumination device is configured to be capable of changing light distribution, which is a radiation position of the reference light. The controller controls light distribution of the reference light by the illumination device according to the discriminated measuring object.

With the above-mentioned configuration, distribution of the reference light radiated from the illumination device is adjusted according to the measuring object discriminated on the basis of detection of the spectrum data. Thereby, discrimination of the measuring object can be stably achieved with high accuracy.

In accordance with one aspect of the present invention, 11. The illumination device uses an LED luminous body as a source of the reference light.

As with the above-mentioned configuration, by using the LED luminous body as the source of the reference light, the wavelength range and the light intensity at each wavelength as the reference light can be adjusted more easily and with high accuracy.

In accordance with one aspect of the present invention, the LED luminous body includes a plurality of LED light-emitting elements that emit light components having different wavelengths and are arranged in a row or a matrix. The controller selectively drives the LED light-emitting elements to control the wavelength range of the reference light, and adjusts the value of a current supplied to the selected LED light-emitting element or the duty cycle of a pulse voltage applied to the selected LED light-emitting element to control the light intensity at each wavelength of the reference light or to control blinking.

With the above-mentioned configuration, through radiation/non-radiation of the reference light by the LED light-emitting elements having different wavelengths, which configure the LED luminous body, the wavelength range of the reference light can be adjusted, and adjustment of the feature value of the observation light detected by the spectrum sensor can be performed more easily and with a simpler configuration.

In accordance with one aspect of the present invention, the illumination device uses a halogen lamp as a source for the reference light.

With the above-mentioned configuration, by using the halogen lamp as the source of the illumination device, the illumination device can be configured more simply.

In accordance with one aspect of the present invention, the illumination device includes a plurality of optical filters having different wavelength characteristics and transmittances, which cover the halogen lamp. Through selection of the optical filters, the controller controls at least one of the wavelength range and the light intensity at each wavelength of the reference light or controls blinking.

With the above-mentioned configuration, the reference light radiated from the halogen lamp is radiated toward the measuring object through the filter selected from a plurality of filters having different wavelength characteristics and transmittances. In other words, the wavelength range and the light intensity at each wavelength of the reference light are adjusted according to the wavelength characteristic and the transmittance of the filter. Thereby, an illumination device that can adjust the feature value of the detected observation light can be configured from a very versatile light source such as a halogen lamp.

In accordance with one aspect of the present invention, the illumination device is provided with a spectroscope for separating light radiated from the halogen lamp according to wavelength. Through adjustment of the phase of the light separated according to wavelength, the controller controls at least one of the wavelength range and the light intensity at each wavelength of the reference light or controls blinking.

With the above-mentioned configuration, the intensity and the wavelength range of the reference light radiated toward the measuring object can be adjusted through phase adjustment of the reference light radiated from the halogen light source. Also in this case, an illumination device that can adjust the feature value of the detected observation light can be configured from a very versatile light source such as the halogen lamp.

In accordance with one aspect of the present invention, the illumination device is provided with a spectroscope for separating light radiated from the halogen lamp according to wavelength. Through selective transmission or restriction of the light separated according to wavelength, the controller controls at least one of the wavelength range and the light intensity at each wavelength of the reference light or controls blinking.

With the above-mentioned configuration, the light radiated from the halogen light source is separated by the spectroscope according to wavelength and the amount of the separated light is adjusted according to wavelength. For this reason, the wavelength range and the light intensity of the reference light radiated from the illumination device can be adjusted through the amount of light according to wavelength. Also in this case, an illumination device that can adjust the feature value of the detected observation light can be configured from a very versatile light source such as the halogen lamp.

In accordance with one aspect of the present invention, the reference light radiated from the illumination device is light having wavelength in a nonvisible region.

With the above-mentioned configuration, by adopting light having wavelengths in the invisible region as the reference light radiated from the illumination device, even when the spectrum data regarding the measuring object such as a pedestrian and a vehicle is detected, the reference light can be radiated without exerting an influence on walking by the pedestrian and driving of the vehicle.

In accordance with one aspect of the present invention, the feature value varying device includes a spectral characteristic varying part for varying an imaging spectral characteristic of the mounted spectrum sensor. The controller controls the imaging spectral characteristic by the spectral characteristic varying part on the basis of the control value, thereby varying the feature value of the observation light.

With the above-mentioned configuration, by adjusting the imaging spectral characteristic of the spectrum sensor, the feature value of the observation light detected by the spectrum sensor can be adjusted. For this reason, in discriminating the measuring object on the basis of the spectrum data detected by the spectrum sensor, the spectrum data corresponding to the attribute of the measuring object or the ambient light to the measuring object can be acquired, resulting in that the measuring object can be discriminated with high accuracy. By using the spectral characteristic varying part (spectrum sensor) and the above-mentioned illumination device concurrently as the feature value varying device, the degree in adjusting the feature value of the observation light as well as the degree of flexibility in adjustment are significantly improved.

In accordance with one aspect of the present invention, the mounted spectrum sensor is a spectrum sensor provided with a CMOS image sensor as an imaging element. The feature value varying device includes a pixel driver of the CMOS image sensor as the spectral characteristic varying part. The controller controls the imaging spectral characteristic by adjusting gain at each pixel of the CMOS image sensor, which corresponds to each light separated according to wavelength, thereby varying the feature value of the observation light.

With the above-mentioned configuration, by adjusting the gain of each row of the CMOS image sensor configuring the hyper spectrum sensor, imaging spectrum, that is, the feature value of the observation light can be adjusted. Thereby, the feature value of the observation light detected from the measuring object can be electrically adjusted and furthermore, an increase in size of the spectrum sensor is prevented.

In accordance with one aspect of the present invention, the mounted spectrum sensor is a multi-spectrum sensor for capturing the observation light into each of a plurality of imaging elements through optical filters having different wavelength characteristics and transmittances. The feature value varying device includes the optical filters having different wavelength characteristics and transmittances as the spectral characteristic varying part. The controller controls the imaging spectral characteristic by synthesizing the observation light captured into each of the imaging element through the optical filters, thereby varying the feature value of the observation light.

With the above-mentioned configuration, by capturing the observation light radiated toward the imaging elements of the multi-spectrum sensor through the optical filters having different wavelength characteristics and transmittances, the observation light, the feature value of which is adjusted according to the wavelength characteristics and transmittances of the optical filters, can be detected. Thus, the feature value of the observation light detected from the measuring object can be easily adjusted.

In accordance with one aspect of the present invention, the mounted spectrum sensor is a multi-spectrum sensor for directing the observation light to each of a plurality of imaging elements having different wavelength ranges. The feature value varying device includes a driver for each of the imaging elements as the spectral characteristic varying part. The controller controls the imaging spectral characteristic by adjusting a gain of each of the imaging elements, thereby varying the feature value of the observation light.

With the above-mentioned configuration, by adjusting the gain of each of the imaging elements configuring the multi-spectrum sensor, the feature value of the observation light detected by the multi-spectrum sensor can be adjusted. Also in this case, the feature value of the observation light is detected from the measuring object can be easily adjusted.

In accordance with one aspect of the present invention, the controller determines the control value corresponding to the environment element on the basis of a detection result of the spectrum sensor.

With the above-mentioned configuration, by determining the control value of the controller that can vary the feature value of the observation light on the basis of the detection result of the spectrum sensor, the feature value of the observation light can be adjusted in a recursive manner. For this reason, even in the situation where the ambient light gradually varies with movement of the movable body, the reference light corresponding to the ambient light can be appropriately radiated toward the measuring object, and the spectrum data can be acquired more desirably.

In accordance with one aspect of the present invention, the movable body is further provided with an environment information sensor for detecting surrounding environment information of the movable body. The controller determines the control value corresponding to the environment element on the basis of a detection result of the environment information sensor.

The spectrum data detected from the measuring object varies depending on, for example, an atmospheric state caused by change in weather, sunlight radiation degree and the like. With the above-mentioned configuration, the environment information sensor can monitor the atmospheric state and the sunlight radiation degree, and the control value determined according to the monitored environment element, that is, the feature value of the observation light can be adjusted. Thus, even when surrounding environment of the movable body varies, the measuring object can be discriminated with influence from the surrounding environment being reduced.

In accordance with one aspect of the present invention, the environment information sensor is an image sensor for acquiring a surrounding image of the movable body.

With the above-mentioned configuration, the image sensor for acquiring the surrounding image of the movable body can monitor the surrounding environment information of the movable body with high accuracy. This can determine the control value of the controller according to the environment element of the movable body, and adjust the feature value of the observation light according to the surrounding environment of the movable body with high accuracy.

In accordance with one aspect of the present invention, the environment information sensor is a radar device for detecting presence or absence of an object in the surroundings of the movable body and the distance from the object on the basis of a reception mode of a reflected wave of a transmitted radio wave.

With the above-mentioned configuration, the radar device can detect the presence or absence of objects surrounding the movable body as the measuring object. This can set the control value corresponding to an object in the surroundings of the movable body, and adjust the feature value of the observation light according to the surrounding environment of the movable body with high accuracy.

In accordance with one aspect of the present invention, the movable body is an automobile moving on a road surface.

The present invention with the above-mentioned configuration is especially effective for the automobile as the movable body provided with the spectrum sensor, and enables very reliable acquisition of discrimination information of the measuring object, which is necessary for supporting driving of the automobile.

### BRIEF DESCRIPTION OF THE DRAWINGS

FIG. 1(a) is a block diagram schematically showing the configuration of a movable body spectrum measuring apparatus according to a first embodiment of the present invention;

FIG. 1(b) is a diagram showing an example of a control value map for an illumination controller and a sensor controller;

FIG. 2(a) is a graph showing an example of spectrum shape of reference light radiated from an illumination device in the first embodiment;

FIG. 2(b) is a graph showing an example of spectrum data regarding a measuring object, which is detected by a spectrum sensor;

FIGS. 3(a) to 3(d) are graphs showing examples of shift of the spectrum data regarding sunlight as ambient light over time;

FIGS. 4(a) and 4(b) are views showing examples of the control value map for the illumination controller in the apparatus according to the first embodiment;

FIG. 5 is a graph showing an example of spectrum shape of reference light generated by the illumination controller in the apparatus according to the first embodiment;

FIGS. 6(a) to 6(d) are graphs showing examples of shift of a wavelength range and the light intensity at each wavelength of the reference light generated by the illumination controller in the apparatus according to the first embodiment over time;

FIG. 7 is a perspective view schematically showing an example of configuration of the illumination device adopted in the first embodiment;

FIG. 8 is a graph showing relationship between wavelength and transmittance of each LED light-emitting element configuring the illumination device shown in FIG. 7;

FIG. 9(a) is a graph showing relationship between a supplied current and the light intensity of the LED light-emitting element configuring the illumination device shown in FIG. 7 in the case of controlling the current and the light intensity of the LED light-emitting element;

FIG. 9(b) is a time chart showing an example of shift of time and an applied pulse voltage in the case of pulse width modulation-controlling the light intensity of the LED light-emitting element configuring the illumination device (duty cycle control);

FIG. 10 is a graph showing an example of spectrum waveform of the reference light radiated from the illumination device shown in FIG. 7;

FIG. 11 is a flowchart showing a procedure of illumination control performed by the illumination controller in the apparatus according to the first embodiment;

FIG. 12 is a side view schematically showing the configuration of an illumination device adopted in a movable body spectrum measuring apparatus according to a second embodiment of the present invention;

FIG. 13 is a front view showing a specific example of an optical filter used in the illumination device shown in FIG. 12;

FIG. 14(a) is a graph showing an example of the wavelength characteristic and transmittance of the optical filter;

FIG. 14(b) is a graph showing relationship between an light intensity and a current supplied to a halogen lamp configuring the illumination device shown in FIG. 12;

FIG. 15 is a diagram schematically showing the configuration of an illumination device adopted in a movable body spectrum measuring apparatus according to a third embodiment of the present invention;

FIG. 16 is a perspective view showing a modification of a part (phase plate) of the illumination device adopted in the third embodiment;

FIGS. 17(a) and 17(b) are partial perspective views schematically showing the configuration of an illumination device adopted in a movable body spectrum measuring apparatus according to a fourth embodiment of the present invention;

FIG. 18 is a graph showing an example of the wavelength range and the light intensity at each wavelength of the reference light radiated from the illumination device shown in FIG. 17;

FIG. 19 is a side view schematically showing the configuration of a spectrum sensor adopted in a movable body spectrum measuring apparatus according to a fifth embodiment of the present invention;

FIG. 20 is a front view schematically showing an imaging surface of a CMOS image sensor configuring the spectrum sensor shown in FIG. 19;

FIG. 21 is a diagram showing an example of the control value map for the sensor controller in the apparatus according to the fifth embodiment;

FIG. 22 is a graph showing an example of sensitivity characteristic (driving characteristic) of the CMOS image sensor shown in FIGS. 19 and 20;

FIG. 23 is a flowchart showing a sensor control procedure performed by the sensor controller in the apparatus according to the fifth embodiment;

FIG. 24 is a perspective view schematically showing the configuration of a spectrum sensor adopted in a movable body spectrum measuring apparatus according to a sixth embodiment of the present invention;

FIG. 25 is a perspective view schematically showing a part of configuration of a spectrum sensor adopted in a movable body spectrum measuring apparatus according to a seventh embodiment of the present invention;

FIG. 26 is a perspective view schematically showing the configuration of a spectrum sensor adopted in a movable body spectrum measuring apparatus according to an eighth embodiment of the present invention;

FIG. 27(a) is a block diagram showing the configuration of a gain adjusting part of each CCD image sensor configuring the spectrum sensor shown in FIG. 26;

FIG. 27(b) is a graph showing an example of a gain adjusting mode of the CCD image sensors;

FIG. 28(a) is a diagram schematically showing an example of an external environment element to the vehicle during non-radiation of the reference light in a movable body spectrum measuring apparatus according to a ninth embodiment of the present invention;

FIG. 28(b) is a graph showing an example of the spectrum data detected by the spectrum sensor during non-radiation of the reference light in this embodiment;

FIG. 29(a) is a diagram schematically showing an example of the external environment element to the vehicle during radiation of the reference light in the ninth embodiment;

FIG. 29(b) is a graph showing an example of the spectrum data detected by the spectrum sensor during radiation of the reference light;

FIG. 30 is a graph showing an example of ratio of each spectrum data during radiation of the reference light to the spectrum data during non-radiation of the reference light in the ninth embodiment;

FIG. 31(a) is a time chart showing an example of a blinking cycle of an electric lamp as a source of the ambient light in the movable body spectrum measuring apparatus according to a tenth embodiment of the present invention;

FIG. 31(b) is a time chart showing an example of the blinking cycle of the reference light radiated from the illumination device in this embodiment;

FIG. 32(a) is a diagram schematically showing an example of the external environment element to the vehicle during non-radiation of the reference light from the illumination device in a movable body spectrum measuring apparatus according to an eleventh embodiment of the present invention;

FIG. 32(b) is a graph showing an example of the spectrum data detected by the spectrum sensor during radiation of the reference light in this embodiment;

FIG. 33(a) is a diagram schematically showing an example of the external environment element to the vehicle during non-radiation of the reference light from the illumination device of the apparatus according to the eleventh embodiment

FIG. 33(b) is a diagram showing an example of difference between the spectrum data during radiation of the reference light and the spectrum data during non-radiation of the reference light;

FIG. 34 is a diagram schematically showing an example of the measuring object of the apparatus according to the eleventh embodiment;

FIG. 35(a) is a graph showing an example of the spectrum shape of the reference light radiated from the illumination device of the apparatus according to the eleventh embodiment

FIG. 35(b) is a graph showing an example of the spectrum data detected by the measuring object during radiation of the reference light together with a discrimination condition;

FIG. 35(c) is a graph showing an example of difference between the spectrum data during radiation and the spectrum data during non-radiation together with the discrimination condition;

FIG. 36 is a diagram showing a determination condition for discriminating the measuring object in the apparatus according to the eleventh embodiment;

FIG. 37 is a block diagram schematically showing the configuration of a movable body spectrum measuring apparatus according to a twelfth embodiment of the present invention; and

FIG. 38 is a diagram showing an example of a light distribution mode of the reference light by the illumination controller in the apparatus according to the twelfth embodiment.

### MODE FOR CARRYING OUT THE INVENTION

### First Embodiment

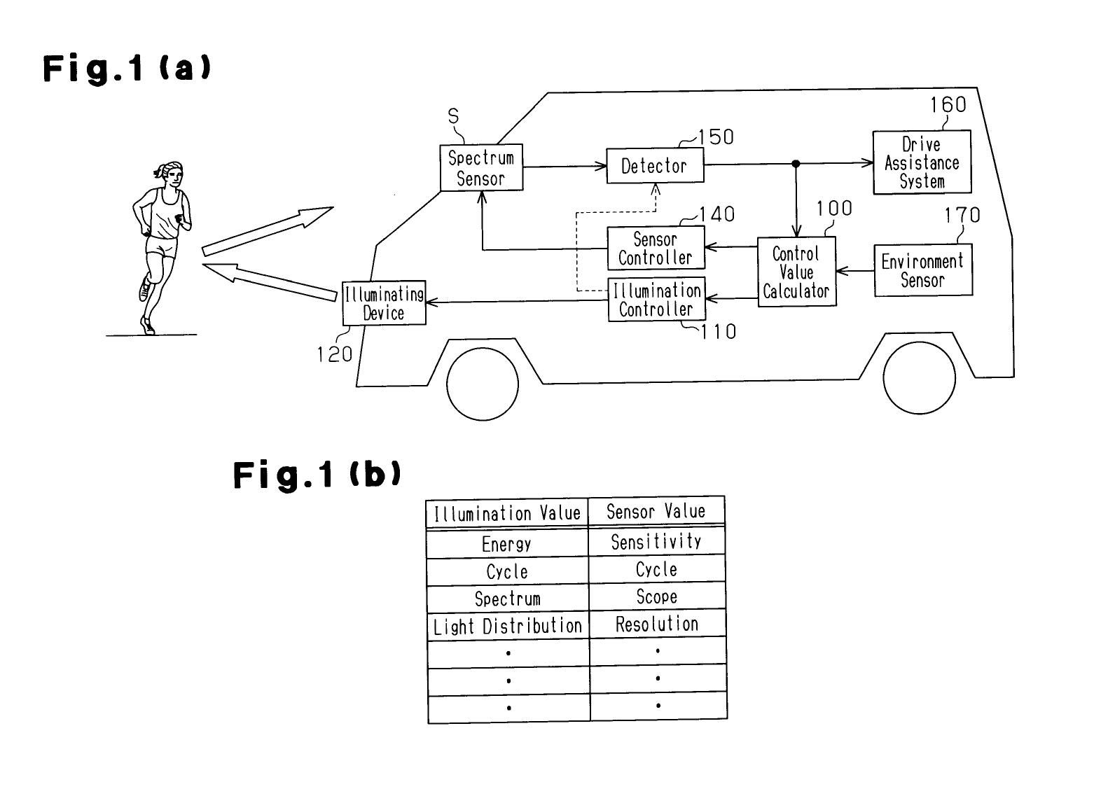

FIG. 1 shows a schematic configuration of a movable body spectrum measuring apparatus according to a first embodiment of the present invention.

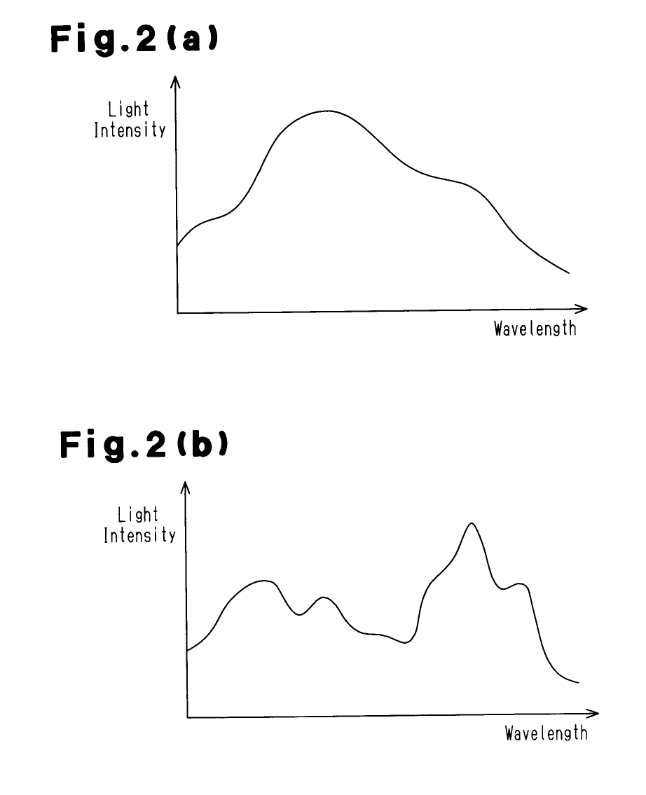

As shown in FIG. 1(a), the movable body spectrum measuring apparatus includes a control value calculator 100 that, in monitoring of a measuring object such as a pedestrian, a traffic light or an obstacle through a spectrum sensor S mounted on a vehicle such as an automobile, controls a radiation mode of reference light radiated toward the measuring object or an imaging spectral characteristic of the spectrum sensor S itself to calculate a control value for varying feature value of a wavelength range and light intensity at each wavelength of observation light, which is detected by the spectrum sensor S. The control value calculator 100 has a control value map as shown in FIG. 1(b), an illumination controller 110 controls illumination of an illumination device 120 on the basis of the control value map, and a sensor controller 140 controls the imaging spectral characteristic of the spectrum sensor S. The control value map stores information regarding energy, cycle, spectrum, light distribution and the like of the reference light, as an illumination value as the control value of the reference light radiated from the illumination device 120. The control value map also stores information regarding sensitivity, cycle, scope, resolution and the like as a sensor value as the control value of the imaging spectral characteristic of the spectrum sensor S. The illumination device 120 as the feature value varying device controlled by the illumination controller 110 is a part that radiates the reference light, the wavelength range and the light intensity at each wavelength of which are controlled according to the control map of the control value calculator 100. For example, when the reference light having the spectrum shape as shown in FIG. 2(a), that is, the wavelength range and the light intensity at each wavelength is radiated from the illumination device 120 to the measuring object such as the pedestrian, reflected reference light is detected as a part of the observation light by the spectrum sensor S. At this time, as shown in FIG. 2(b), the spectrum data detected by the spectrum sensor S indicates the wavelength characteristic corresponding to the attribute of the measuring object and the feature value varies depending on the reference light.

Further, in the spectrum sensor S, the sensor controller 140 can vary the imaging spectral characteristic according to the control value map of the control value calculator 100, thereby varying the feature value of the detected observation light. When the spectrum sensor S detects the spectrum data regarding the measuring object, then the spectrum data is captured into a detector 150, and it is discriminated whether the measuring object is a pedestrian, traffic light or an obstacle on the basis of the feature value of the spectrum data. Then, discriminating information of the measuring object is recursively captured into the control value calculator 100. The discriminating information of the measuring object is also captured into a drive assistance system 160 that cyclically operates various types of information for supporting driving of the vehicle to supply drive assistance such as navigation and auto-cruise control to the driver, and also serves as driving assistance by the system 160.

In addition to the spectrum data regarding the measuring object, which is detected by the spectrum sensor S, information detected by an environment information sensor 170 formed of, for example, an image sensor for acquiring positional information of the vehicle by GPS and images surrounding the vehicle or a radar device for detecting presence or absence of an object surrounding the vehicle and distance from the object on the basis of the reception mode of the reflected wave of the transmitted radio wave is captured into the control value calculator 100. Thus, it becomes possible to monitor the environment elements such as the atmospheric state (weather) and the obstacle surrounding the vehicle, which can exert an influence in discriminating the measuring object on the basis of the spectrum data.

As described above, the control value calculator 100 determines the control value in order to radiate the appropriate reference light to the measuring object according to discriminating information of the measuring object from the detector 150 or various environment information from the environment information sensor 170, and to detect the appropriate attribute of the measuring object from the spectrum sensor S.

In this embodiment, first, an example of adjusting the reference light on the basis of solar radiation information among the environment elements, that is, adjusting the feature value of the observation light will be described.

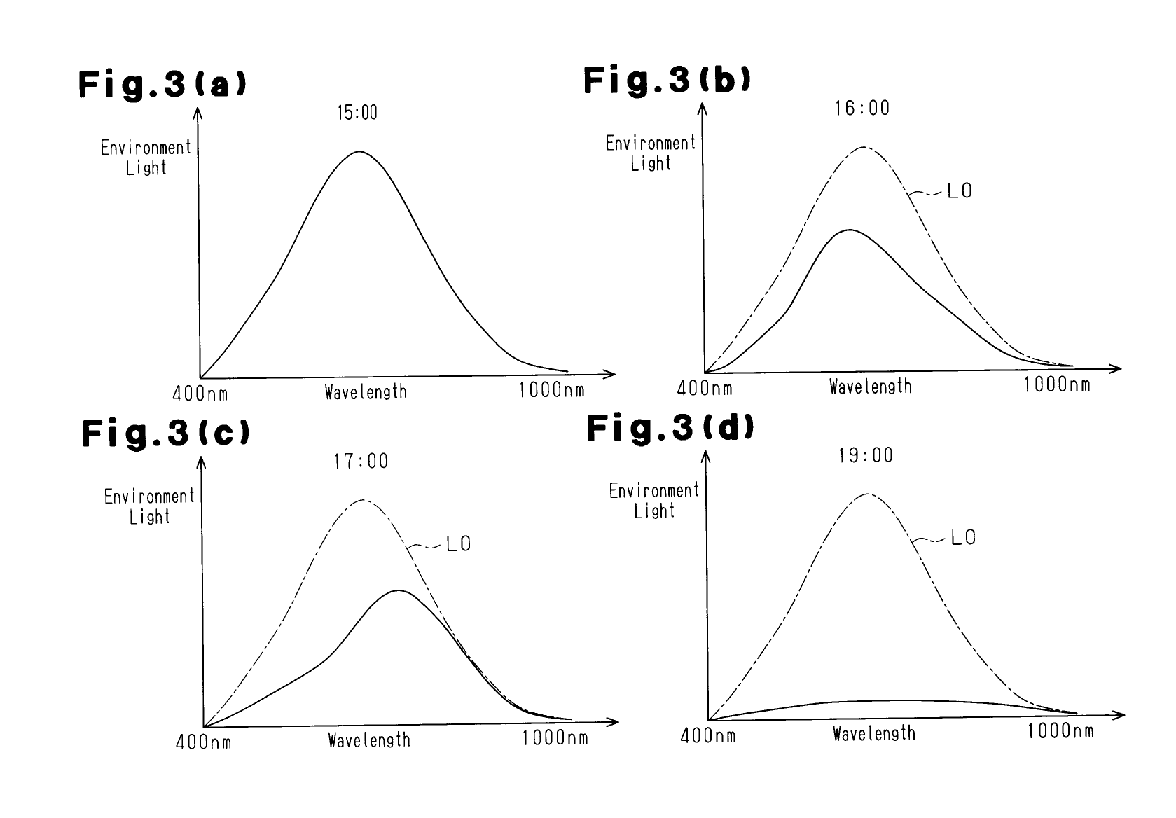

FIGS. 3(a) to 3(b) show examples of shift of the light intensity at each wavelength of sunlight as the ambient light in Japan. FIGS. 3(a) to 3(d) show shift of the light intensity at each wavelength of sunlight having wavelengths of “400 nm” to “1000 nm” at 15:00, 16:00, 17:00 and 19:00, respectively. A curve L0 as a broken line in each of FIGS. 3(b) to 3(d) shows the spectrum shape of sunlight at 15:00.

As shown in FIGS. 3(a) to 3(d), the light intensity at each wavelength of sunlight as the ambient light varies depending on a time zone, and shifts so as to gradually lower from a peak at 15:00. For this reason, even when the same spectrum data regarding the measuring object is detected by the spectrum sensor S, for example, at 15:00 and 19:00, the spectrum data varies due to a change in the intensity in each wavelength range of sunlight as the ambient light. Further, since the light intensity at each wavelength of sunlight lowers over time, the intensity of the spectrum data detected by the spectrum sensor S does not reach a sufficient value required to discriminate the measuring object. In consideration of such actual situations, in this embodiment, the reference light, the light intensity in each wavelength range of which is adjusted so as to compensate change in sunlight as the ambient light, is radiated from the illumination device 120 to the measuring object.

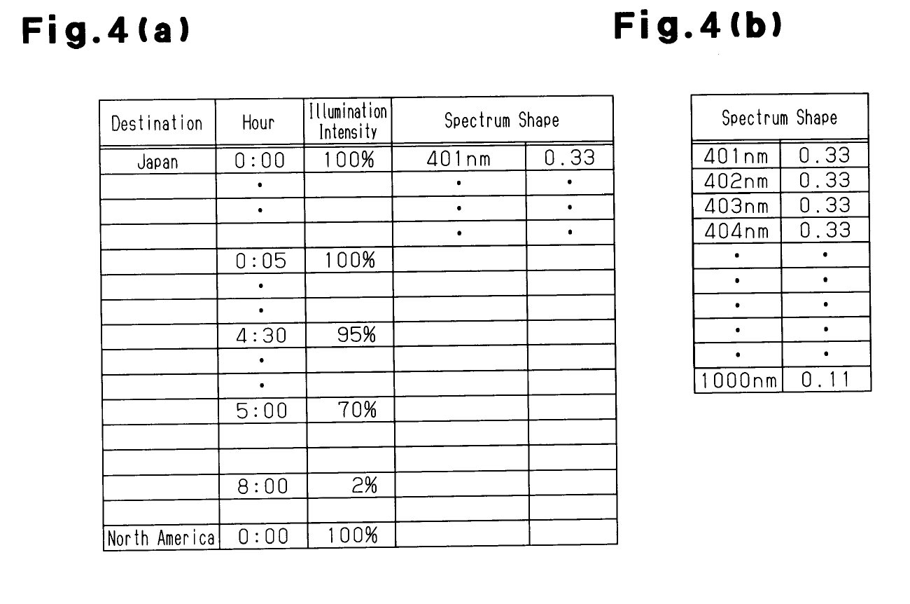

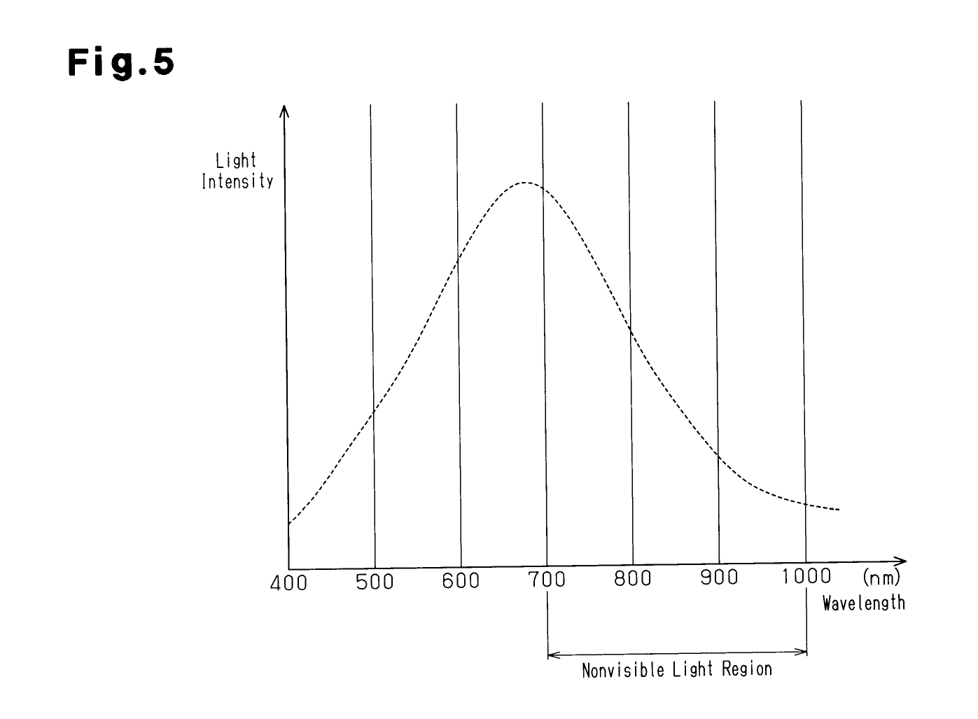

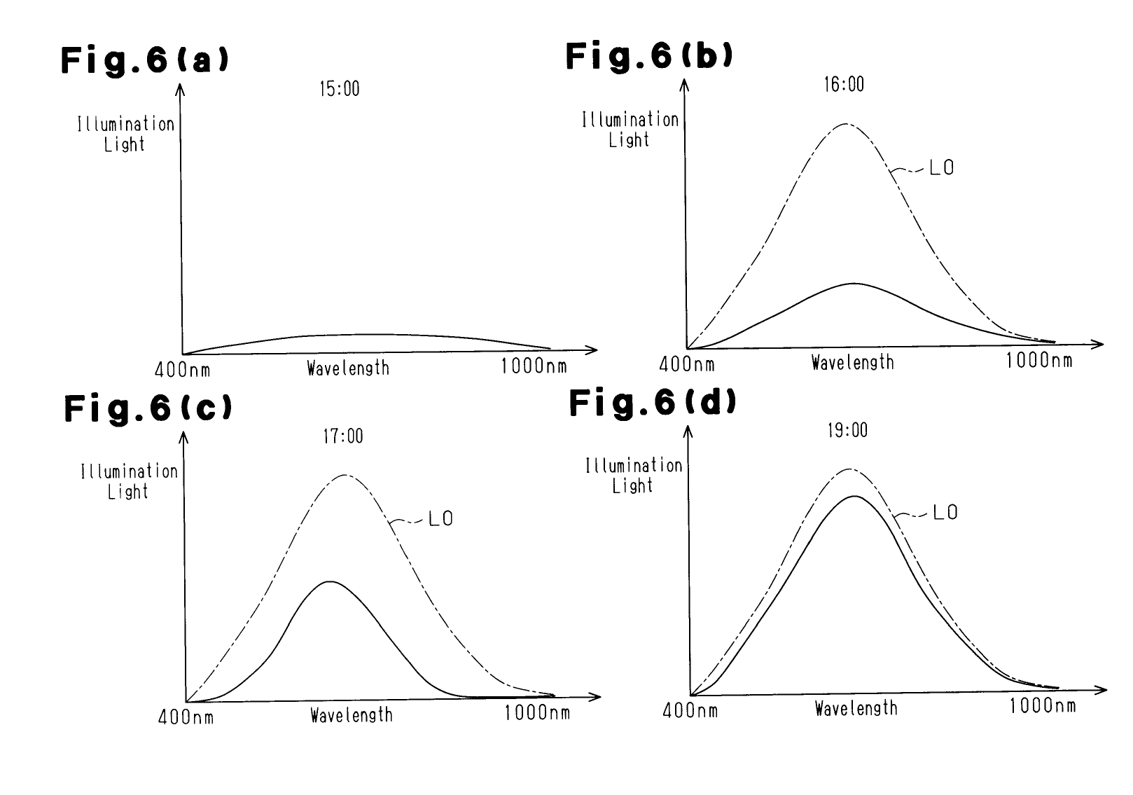

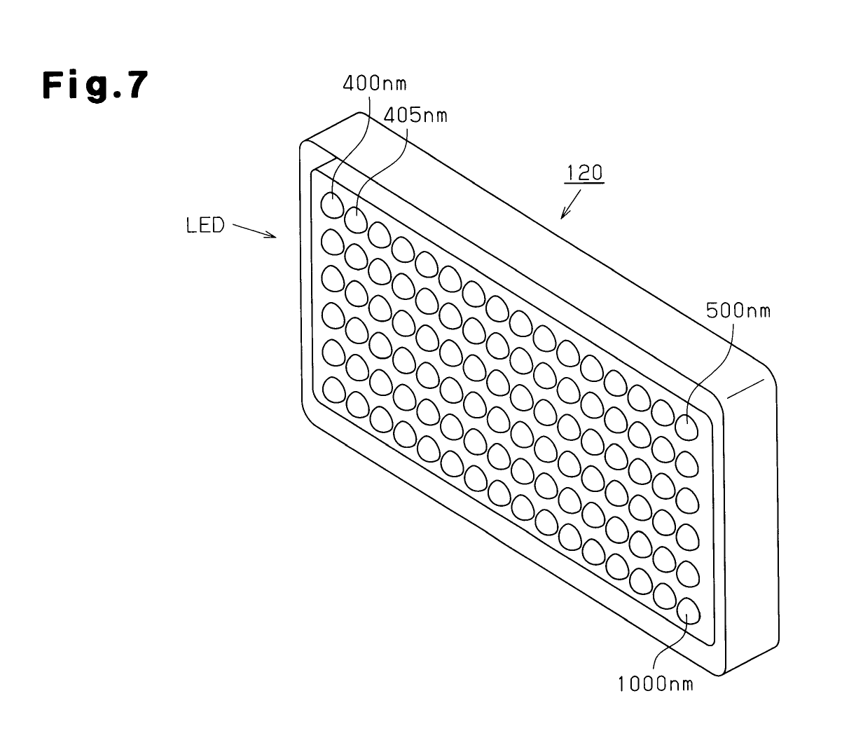

First, a mode of adjusting the reference light will be described with reference to FIGS. 4 to 6. FIG. 4 shows an example of the control value map of the control value calculator 100, and FIGS. 5 and 6 show the spectrum shape of the reference light generated on the basis of the control value map.

First, as shown in FIG. 4(a), the control value map is roughly divided into countries in which the vehicle is used, and the radiation intensity and the spectrum shape are set at each hour so as to correspond to a solar radiation characteristic in each country as a destination. As shown in FIG. 4(b), in the spectrum shape, the light intensity is set in unit of “1 nm” in the wavelength range of “401 nm” to “1000 nm”. For example, the light intensity is “0.33” in the wavelength range of “401 nm”. For example, in the case of Japan at “0:00”, as shown in FIG. 5, the reference light of the illumination intensity of “100%”, in which the light intensity is set in each of the wavelength range of “400 nm” to “1000 nm”, is generated. An invisible light region of “700 nm” to “1000 nm” in the wavelength range is desirable as the wavelength range of the reference light, which enables radiation of the reference light to the measuring object without exerting any effect on walking of a pedestrian and driving a car coming in the opposite direction.

As shown in FIGS. 6(a) to 6(d), which correspond to FIGS. 3(a) to 3(d), respectively, the light intensity at each wavelength of the reference light generated based on the control value map is gradually increased so as to compensate the light intensity in each wavelength range of sunlight, which lowers over time. For this reason, even when the light intensity in each wavelength range of sunlight as the ambient light varies, the reference light, the wavelength range and the intensity in each wavelength range of which are adjusted, is radiated toward the measuring object. Thereby, the spectrum data regarding the measuring object can be acquired without being influenced by the ambient light.

Next, an example of the illumination device 120 will be described with reference to FIG. 7.

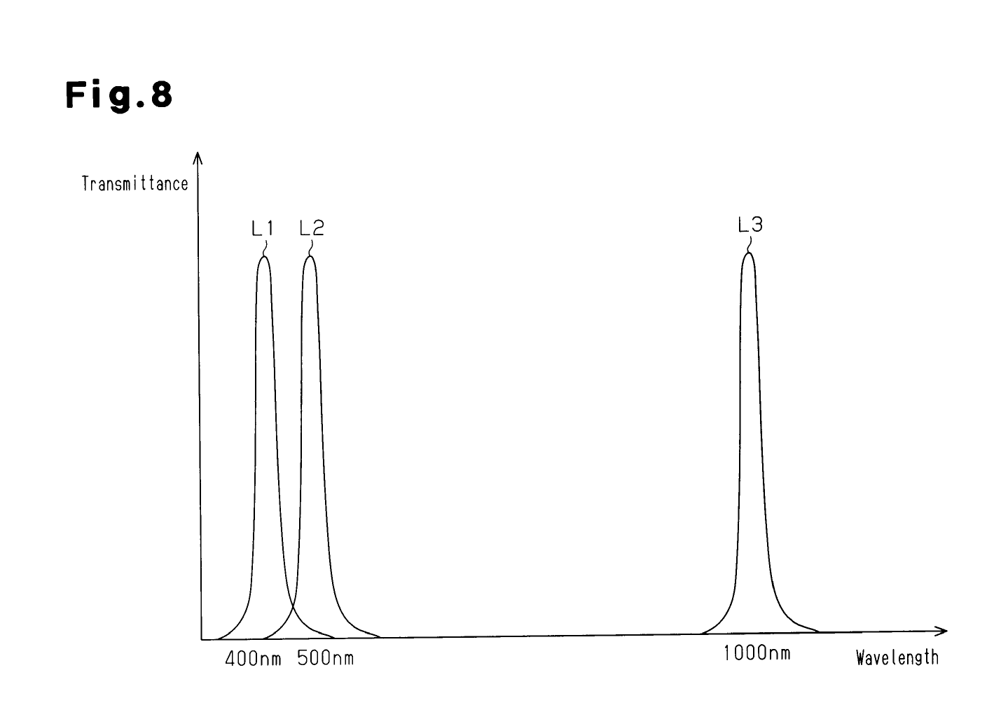

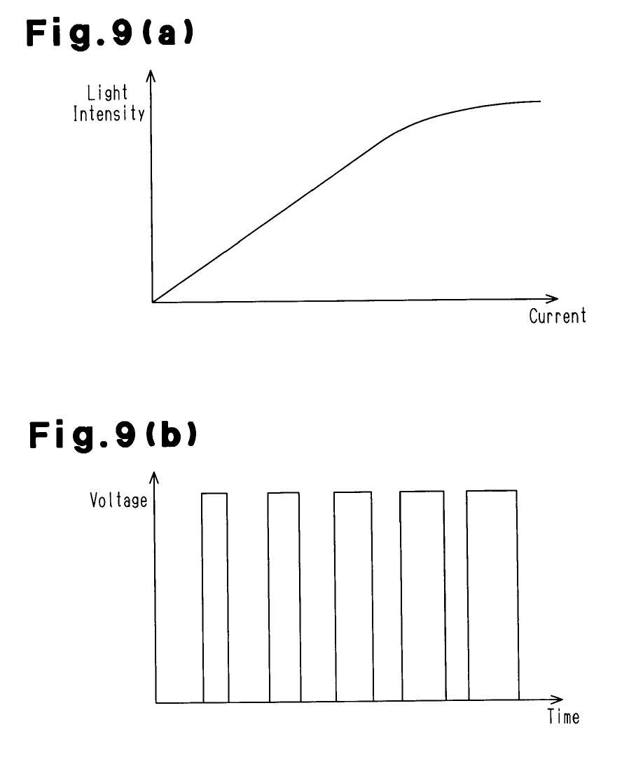

As shown in FIG. 7, the illumination device 120 uses an LED luminous body configured of a plurality of LED light-emitting elements that are arranged in a matrix and emit light having different wavelengths as a light source. Describing in detail, the illumination device 120 is configured of the LED light-emitting elements having different wavelength ranges set by “5 nm” in the range of “400 nm” to “1000 nm”. Each LED light-emitting element has the characteristic of emitting light of short wavelength, and the wavelength range is determined according to content of an impurity contained in the LED light-emitting element. In this embodiment, the LED light-emitting elements having short wavelength adjusted by “5 nm” in the range of “400 nm” to “1000 nm” configure the LED luminous body. For example, the spectrum shape of the LED light-emitting elements having the wavelength ranges of “400 nm”, “500 nm” and “1000 nm” becomes specific in the respective wavelength ranges as represented by curves L1 to L3 in FIG. 8. Adjustment of the light intensity of each LED light-emitting element is, as shown in FIG. 9(a), performed by controlling a value of a current supplied to each LED light-emitting element. That is, as shown in FIG. 9(a), the light intensity of the LED light-emitting elements is nearly proportional to the value of the current supplied to the LED light-emitting elements, and as the value of the current supplied to the LED light-emitting elements becomes larger, the light intensity of the LED light-emitting elements is increased. As shown in FIG. 9(b), the light intensity of each LED light-emitting elements can be also adjusted by pulse width modulation control (duty cycle control), and as the duty cycle of a pulse voltage applied to the LED elements increases, an average value of the current flowing to the LED light-emitting elements becomes larger and the light intensity is increased.

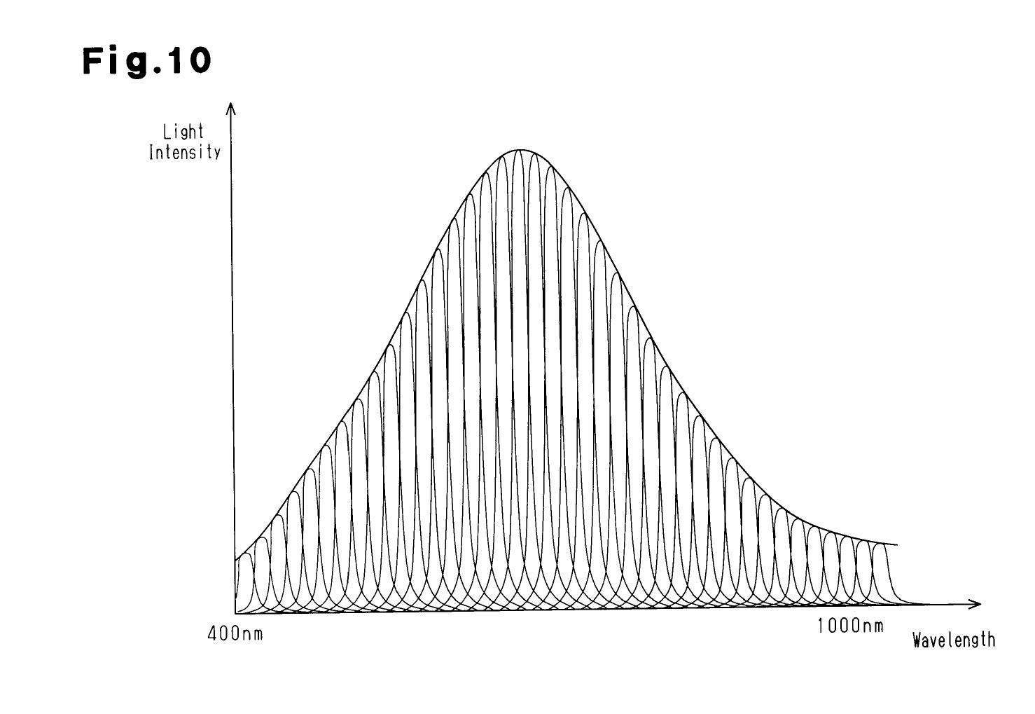

By control of the current supplied to each LED light-emitting element, that is, adjustment of the light intensity, as shown in FIG. 10, the reference light having the wavelength range and the light intensity at each wavelength, which is obtained by synthesizing light emitted from the LED light-emitting elements, is generated.

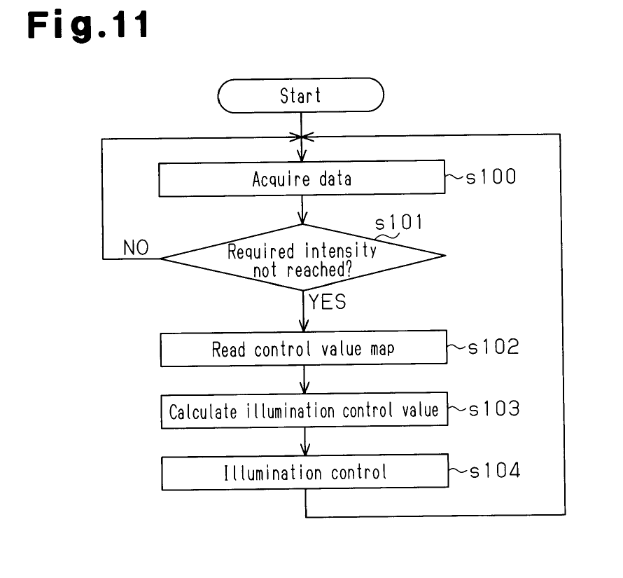

Next, a reference light control mode performed by the control value calculator 100 and the illumination controller 110 on the assumption of the above-mentioned description will be described with reference to FIG. 11.

First, when the spectrum data regarding the measuring object is acquired on the basis of detection by the spectrum sensor S, it is determined whether or not the acquired spectrum data has sufficient intensity required to discriminate the measuring object or more (Steps S100, S101). When it is determined that the intensity of the spectrum data falls below the required intensity, the wavelength range and the intensity in each wavelength range of the reference light at this time is acquired from the control value map (FIG. 4) (Step S101: YES, S102). Then, an illumination control value for controlling the wavelength range and light intensity, energy, cycle and spectrum in the wavelength range of the reference light is operated on the basis of the acquired control value map (Step S103). Then, the above-mentioned illumination control of each of the LED light-emitting elements configuring the illumination device 120 is performed on the basis of the acquired illumination control value (Step S104).

Thus, even when the intensity of the spectrum data falls below the required intensity due to influence of sunlight, by radiating the reference light to the measuring object so as to compensate sunlight, the measuring object can be discriminated with high reliability without being influenced by sunlight.

As described above, the movable body spectrum measuring apparatus according to this embodiment can obtain the following advantages.

(1) By radiating the reference light to the measuring object in acquiring the spectrum data regarding the measuring object, light reflected from the measuring object is detected as the observation light of the measuring object by the spectrum sensor S. Thereby, even in an environment in which reference light such as sunlight does not exist, the spectrum sensor can measure the spectrum of the measuring object.

(2) The wavelength range and the light intensity at each wavelength of the reference light radiated from the illumination device 120 are adjusted in the mode to compensate change in the wavelength range and the light intensity at each wavelength of sunlight in the ambient light, that is, the feature value. Thereby, in discriminating the measuring object on the basis of the spectrum data regarding the measuring object, which is detected by the spectrum sensor S, influence of sunlight, that is, influence of the ambient light can be reduced, enabling discrimination of the measuring object with higher reliability.

(3) The LED luminous body configured of a plurality of LED light-emitting elements that are arranged in a matrix and emit light having different wavelengths is used as a light source of the illumination device 120. Thereby, the wavelength range and the light intensity at each wavelength of the reference light can be controlled with high accuracy and with high degree of flexibility by controlling the value of the current supplied to each LED light-emitting element or duty cycle of the pulse voltage applied to each LED light-emitting element.

### Second Embodiment

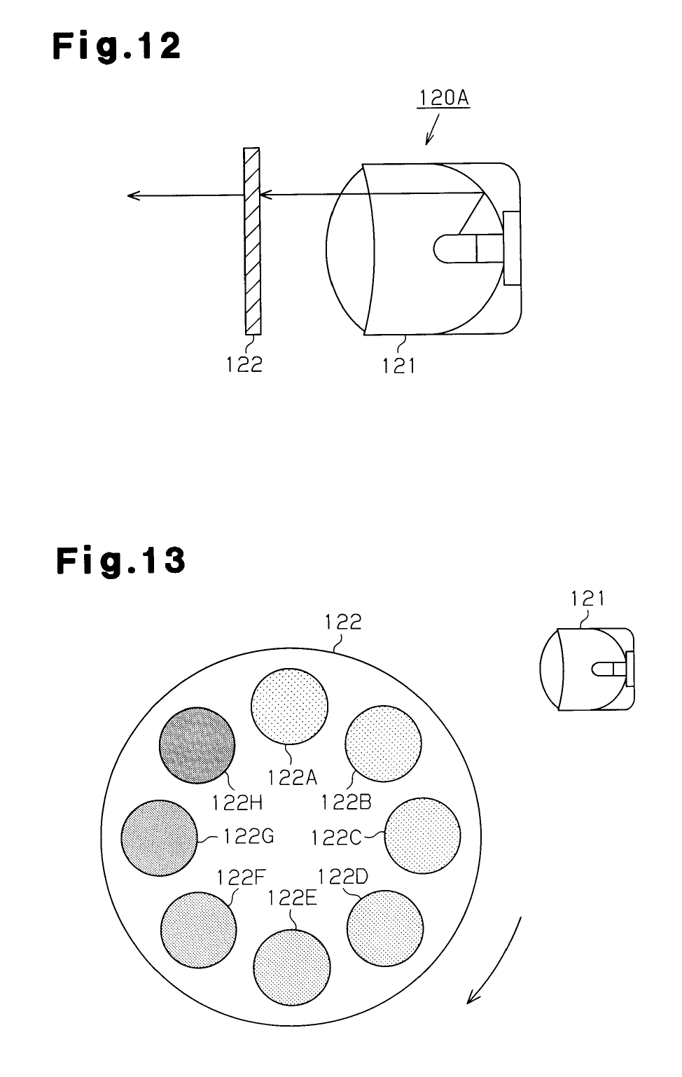

A movable body spectrum measuring apparatus according to a second embodiment of the present invention will be described below with reference to FIGS. 12 to 14. In the second embodiment, the light source of the illumination device is the halogen lamp and its basic configuration of this embodiment is common to that of the first embodiment.

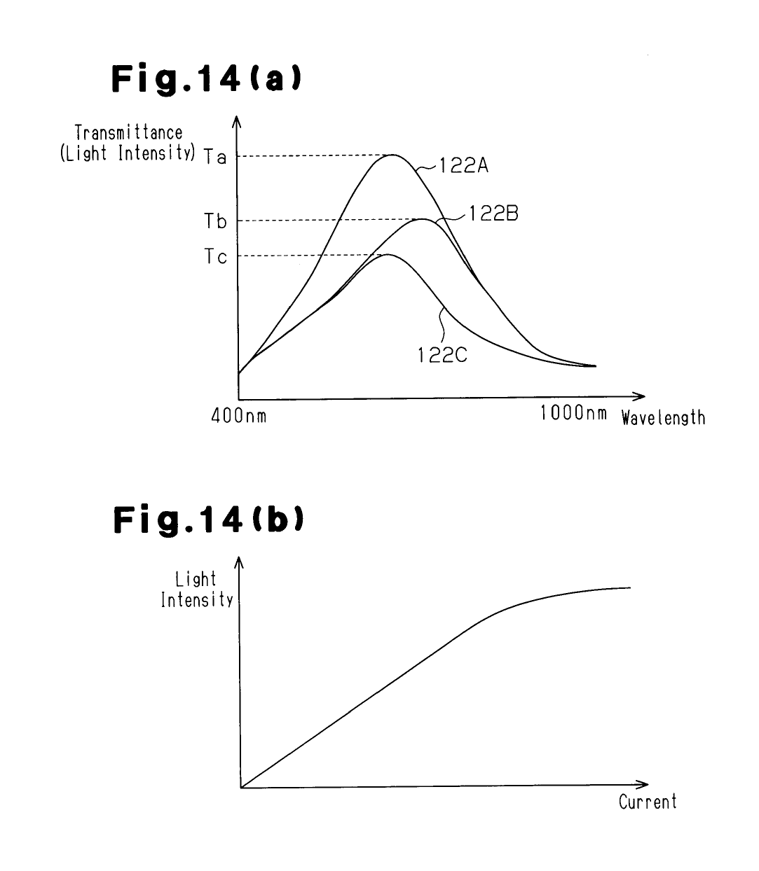

That is, as shown in FIG. 12, an illumination device 120A adopted in this embodiment is configured of a halogen lamp 121 and an optical filter varying plate 122 that covers a surface of the halogen lamp 121. As shown in FIG. 13, the optical filter varying plate 122 is configured of a plurality of optical filters 122A to 122H having different wavelength characteristics and transmittances. The wavelength range and the light intensity at each wavelength of the reference light radiated from the illumination device 120 are changed through selection among the optical filters 122A to 122H. As shown in FIG. 14(a), transmittances Ta to Tc of the optical filters 122A to 122C among these filters has the following relationship:

Ta>Tb>Tc.

The reference light passes through the optical filters 122A to 122C, so that the spectrum shape is converted according to each of the transmittances Ta to Tc, thereby varying the wavelength range and the light intensity at each wavelength of the reference light. The intensity of the halogen lamp 121 is, as shown in FIG. 14(b), substantially proportional to a value of a current supplied to the halogen lamp 121. For this reason, the light intensity of the reference light can be also varied by controlling the current value.

As described above, the illumination device 120A can also vary the wavelength range and the light intensity at each wavelength of the reference light on the basis of the control value map according to the environment element. Thus, even when the ambient light changes, the reference light can be radiated in the mode to compensate the change and accordingly, the spectrum data can be acquired while being less influenced by the ambient light.

As described above, the movable body spectrum measuring apparatus according to the second embodiment can obtain advantages similar to the advantages (1) and (2) in the first embodiment, and the following advantage in place of the advantage (3).

(4) The illumination device 120A is configured of the halogen lamp 121 and the optical filter varying plate 122 including the optical filters 122A to 122H having different wavelength characteristics and transmittances. Thus, in adjusting the wavelength range and the light intensity at each wavelength of the reference light radiated toward the measuring object, the illumination device can be configured of a very versatile light source such as a halogen lamp.

### Third Embodiment

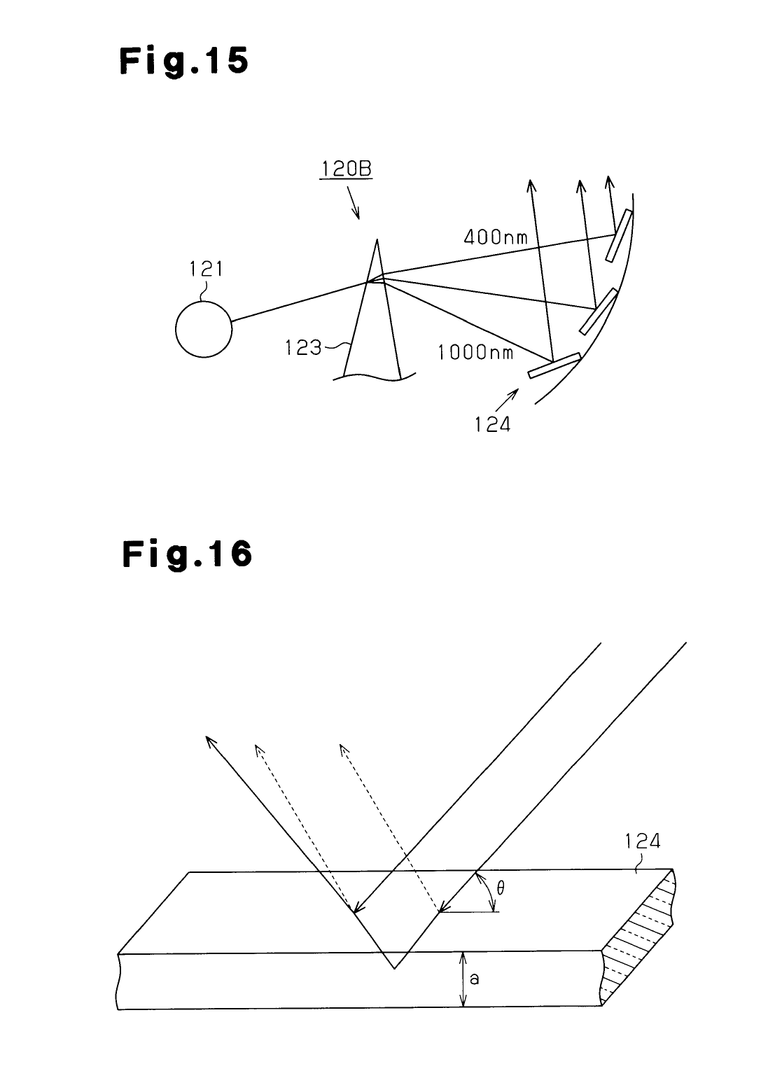

A movable body spectrum measuring apparatus according to a third embodiment of the present invention will be described below with reference to FIGS. 15 and 16. In the third embodiment, like the second embodiment, the light source of the illumination device is the halogen lamp and its basic configuration is common to that of the first embodiment. In the third embodiment, the wavelength range and the light intensity at each wavelength of the reference light radiated from the illumination device are adjusted by light interference.

That is, an illumination device 120B adopted in this embodiment includes, as shown in FIG. 15, a spectroscope 123 such as a prism that separates light radiated from the halogen lamp 121 according to wavelength. The light separated by the spectroscope 123 is diffracted by phase plates 124 provided corresponding to the light wavelength. At this time, the phase of each of the separated light wavelengths is adjusted by inclination of the phase plates 124. When each of the separated lights is in the same phase through such phase adjustment, the light intensity at the wavelength is increased due to light interference. In contrast, when each of the separated light is in opposite phases through phase adjustment, the light intensity at the wavelength is decreased due to light diminishing interference. The light separated according to wavelength and thus phase-adjusted is radiated as the reference light from the illumination device 120B.

As shown in FIG. 16, such light interference also depends on a thickness “a” of the phase plates 124, and therefore, the wavelength range and the light intensity at each wavelength of the reference light can be adjusted according to the thickness “a” of the phase plates 124.

As described above, the movable body spectrum measuring apparatus according to the third embodiment can obtain advantages similar to the advantages (1) and (2) obtained in the first embodiment, and the following advantage in place of the advantage (3).

(5) The wavelength range and the light intensity at each wavelength of the reference light radiated from the illumination device 120B can be phase-adjusted by the phase plates 124 configuring the illumination device 120B. Thus, in adjusting the wavelength range and the light intensity at each wavelength of the reference light radiated toward the measuring object, the illumination device can be configured of the very versatile light source such as the halogen lamp.

### Fourth Embodiment

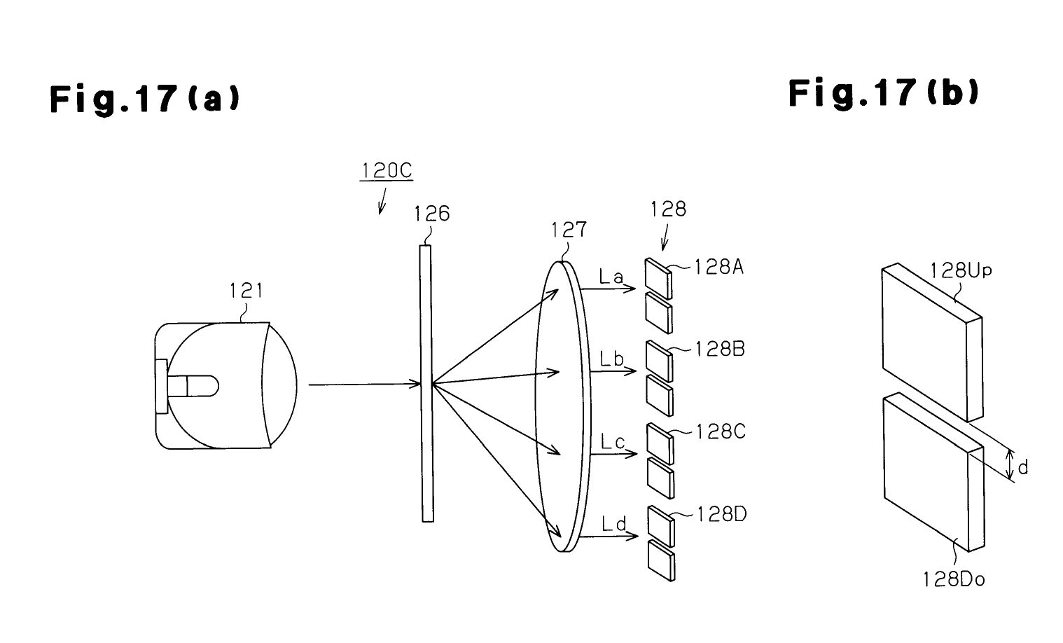

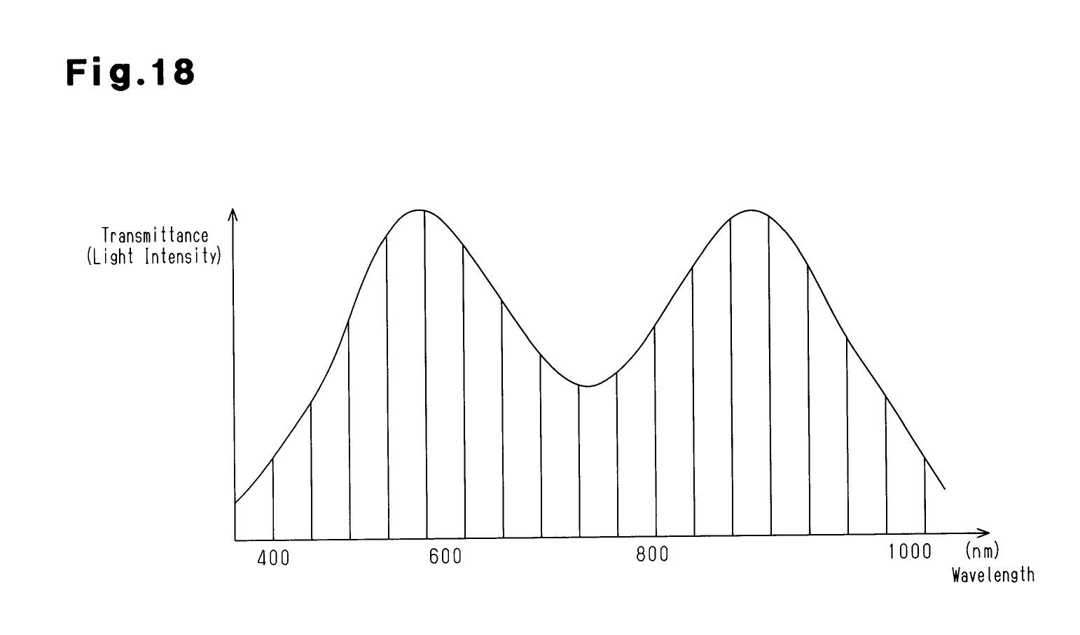

A spectrum measuring apparatus according to a fourth embodiment of the present invention will be described below with reference to FIGS. 17 and 18. In the fourth embodiment, like the second and third embodiments, the light source of the illumination device is the halogen lamp, and its basic configuration is common to that of the first embodiment.

That is, in an illumination device 120C adopted in this embodiment, as shown in FIG. 17(a), first, the light radiated from the halogen lamp 121 is separated according to wavelength through a slit 126. The light separated according to wavelength through the slit 126 is converted into parallel light through a parallel lens 127. For example, the parallel light La to Ld separated at “400 nm”, “600 nm”, “800 nm” and “1000 nm” are radiated as the reference light to the measuring object through a plurality of shielding plates 128A to 1280 for selective transmission and restriction by adjusting the light amount.

The shielding plates 128 (128A to 128D) are, as shown in FIG. 17(b) as an enlarged view, configured of a pair of plate members 128Up and 128Do. By adjusting a distance d between the pair of plate members 128Up and 128Do, the amount of parallel light passing through the shielding plates 128 is adjusted.

By performing selective transmission and restriction of the light La to Ld separated according to wavelength through the shielding plates 128, as shown in FIG. 18, the reference light having the spectrum shape with adjusted wavelength range and light intensity at each wavelength is generated.

As described above, the illumination device 120C can also vary the wavelength range and the light intensity at each wavelength of the reference light on the basis of the control value map according to the environment element. Thus, even when the ambient light changes, the reference light can be radiated so as to compensate for the change and accordingly, the spectrum data can be acquired while being less influenced by the ambient light.

As described above, the movable body spectrum measuring apparatus according to the fourth embodiment can obtain advantages similar to the advantages (1) and (2) in the first embodiment, and the following advantage in place of the advantage (3).

(6) The light radiated from the halogen lamp 121 is separated according to wavelength, and the wavelength range and the light intensity at each wavelength of the reference light radiated from the illumination device 120C are adjusted through selective transmission and restriction of the separated light. Thus, in adjusting the wavelength range and the light intensity at each wavelength of the reference light radiated toward the measuring object, the illumination device can be configured of a very versatile light source such as the halogen lamp.

### Fifth Embodiment

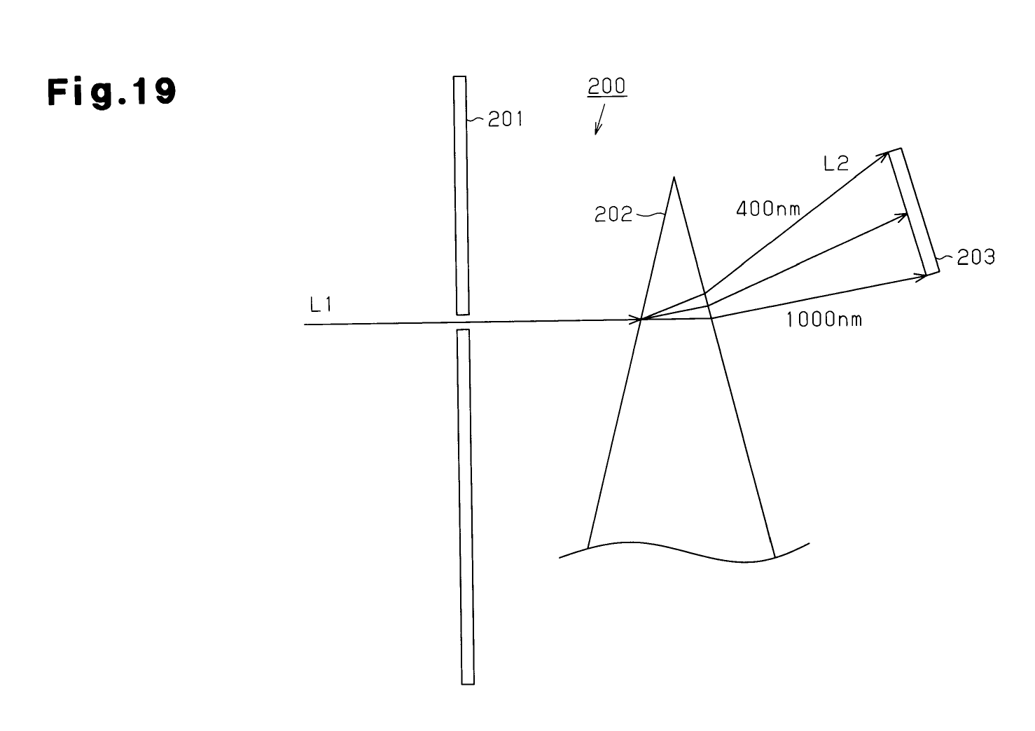

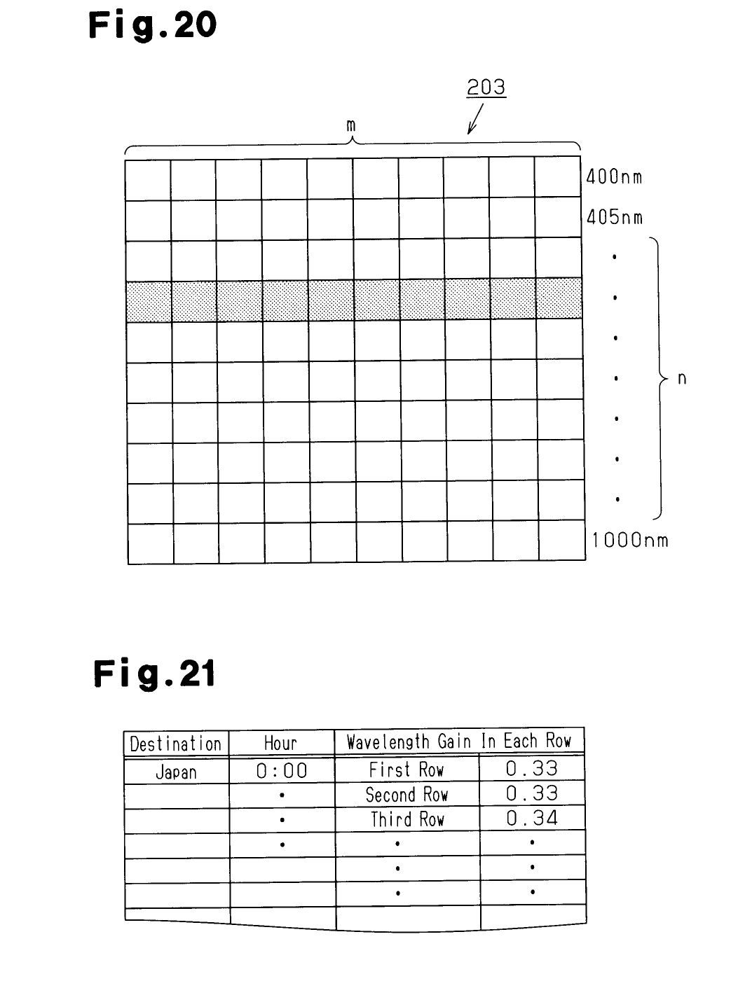

A spectrum measuring apparatus according to a fifth embodiment of the present invention will be described below with reference to FIGS. 1 and 19 to 22. In the fifth embodiment, a hyper spectrum sensor is used as the spectrum sensor S. The sensor controller 140 that can vary the imaging spectral characteristic of the spectrum sensor S is used as the feature value varying device that can vary the feature value of the wavelength range and the light intensity at each wavelength of the observation light, and the sensor controller 140 controls the spectral characteristic varying part provided in the spectrum sensor S. FIGS. 19 and 20 show schematic configuration of the spectral characteristic varying part used herein.

First, as shown in FIG. 19, in a spectral characteristic varying part 200 configured as the hyper spectrum sensor itself, observation light L1 from the measuring object is captured through a slit 201 and then, is separated by a spectroscope 202, for example, by “5 nm”, and images of the separated light L2 are formed on a CMOS image sensor 203. Each pixel driver of the CMOS image sensor 203 adjusts the feature value of the image-formed observation light. FIG. 20 shows schematic configuration of an imaging surface of the CMOS image sensor 203.

As shown in FIG. 20, the CMOS image sensor 203 is configured of, for example, a plurality of unit pixels arranged in a matrix of m columns and n rows, and can sequentially read a pixel signal acquired from each of the unit pixels one by one. Describing in detail, in the CMOS image sensor 203, m column signal lines for transmitting the pixel signals generated from the n unit pixels aligned in the vertical direction and n horizontal selecting lines for selecting the unit pixels operated in units of m, which are aligned in the horizontal direction, are provided in a grid pattern. An image signal is acquired by sequentially scanning the n×m unit pixels one by one by the column signal lines and the horizontal selecting lines.

In the CMOS image sensor 203, the light wavelengths L2 separated by “5 nm” are spread for each pixel. Then, by adjusting a gain of each pixel of the CMOS image sensor 203 by using the sensor controller 140, the feature value of the observation light wavelengths L2 spread by, for example, “5 nm” is adjusted.

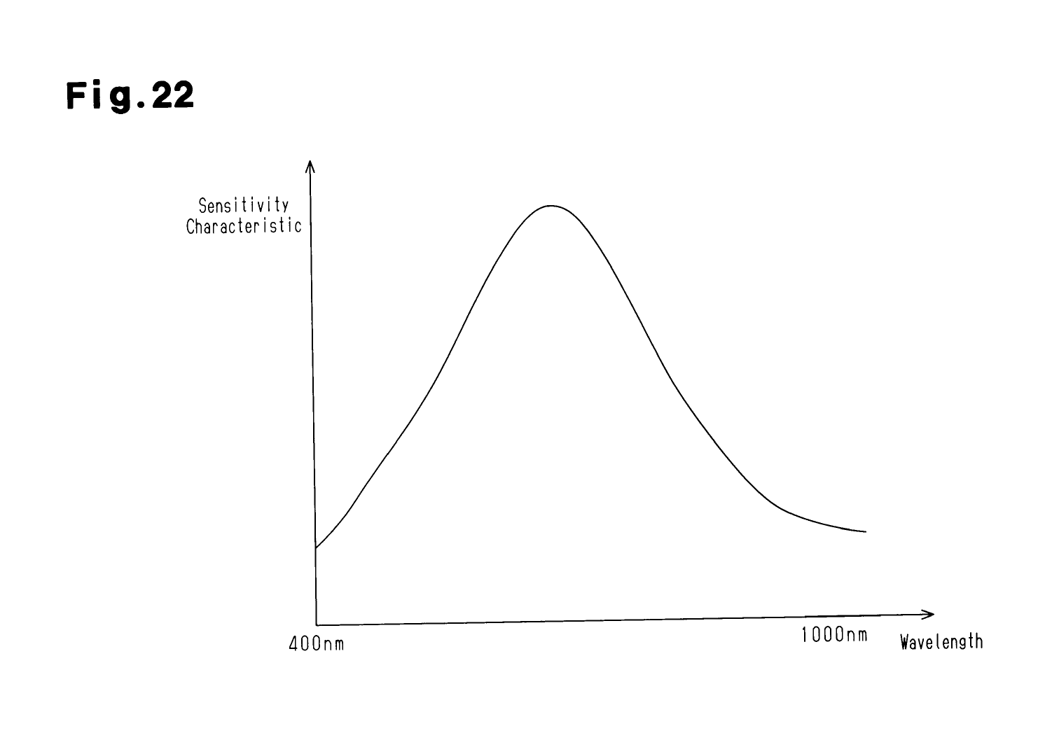

As shown in FIG. 21 showing an example of the control value map of the control value calculator 100, the spectral characteristic varying part 200 having such a configuration can set the gain of each pixel according to the country in which the sensor 203 is used and the hour that are set in order to eliminate influence of sunlight. As a result, as shown in FIG. 22, the sensitivity characteristic of the CMOS image sensor 203 is adjusted for each wavelength, and the feature value of the observation light can be extracted in the mode to compensate for change in sunlight.

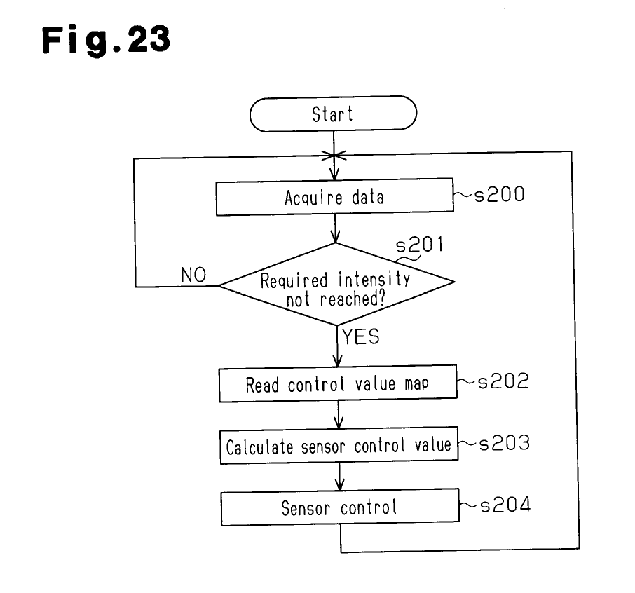

Next, a mode of controlling the sensitivity characteristic of the CMOS image sensor 203 by the control value calculator 100 and the sensor controller 140 on the assumption of the above-mentioned situation will be described with reference to FIG. 23.

First, when the spectrum data regarding the measuring object is acquired on the basis of the spectrum sensor S, it is determined whether or not the intensity of the acquired spectrum data is an intensity required to discriminate the measuring object or larger (Steps S200, S201). When it is determined that the intensity of the spectrum data is smaller than the required intensity, wavelength range and the intensity in each wavelength range of the reference light at this time are acquired from the control value map (FIG. 21) (Step S201:YES, S202). Then, a sensor control value for controlling sensitivity of the CMOS image sensor 203 is operated on the basis of the acquired control value map (Step S203). Then, adjustment of the gain of each pixel, that is, control of the sensitivity characteristic in the CMOS image sensor 203 are performed on the basis of the acquired sensor control value (Step S204).

The CMOS image sensor 203, the sensitivity characteristic of which is adjusted, appropriately detects the spectrum data regarding the measuring object (image formation). Thereby, even when the intensity of the spectrum data falls below the required intensity due to influence of the ambient light, the feature value of the observation light is adjusted in the mode to compensate influence of the ambient light, and through this adjustment, the measuring object can be discriminated with higher reliability without being influenced by the ambient light.

As described above, the movable body spectrum measuring apparatus according to the fifth embodiment can obtain the following advantages.

(7) Basically, only through control of each pixel driver of the COMS image sensor 203 configuring the imaging element of the spectrum sensor S (hyper spectrum sensor), the feature value of the observation light detected from the measuring object can be adjusted.

(8) Since the feature value of the observation light is performed in a purely electrical manner, an increase in size of the spectrum sensor S is prevented.

(9) The illumination controller 110 and the illumination device 120 in FIG. 1 can be omitted. However, by concurrently using the configuration of any of the first to fourth embodiments with the illumination controller 110 and the illumination device 120, the advantages (1) to (6) obtained in these embodiments can be also obtained.

### Sixth Embodiment

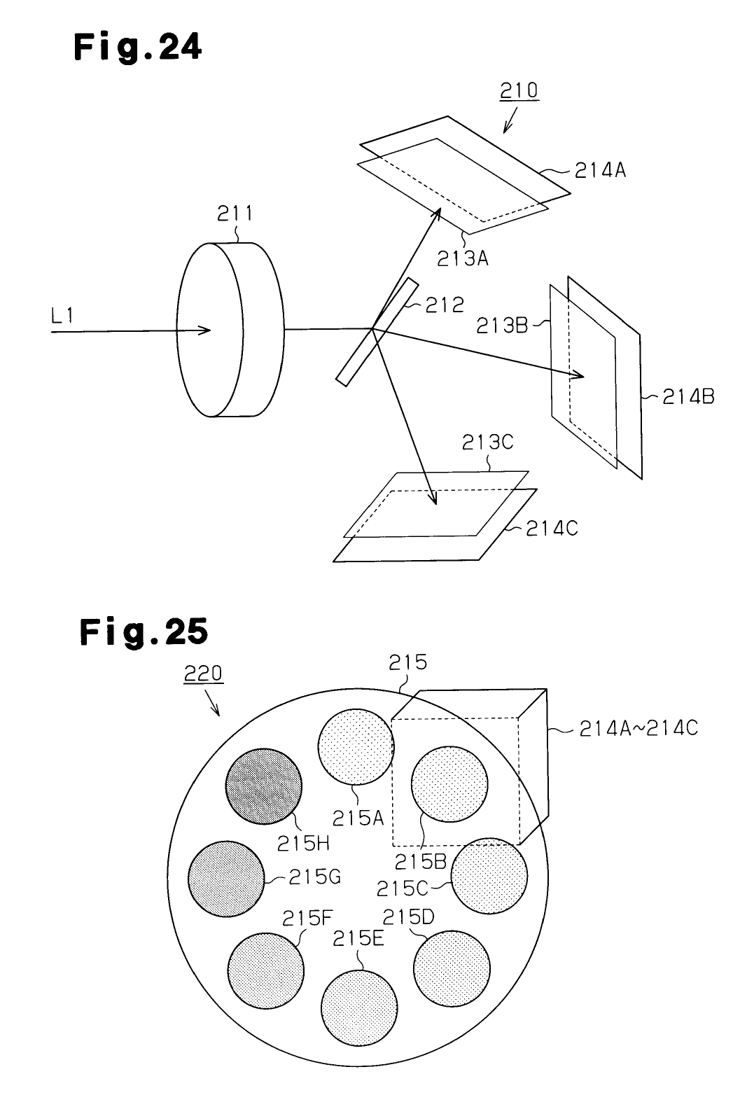

A movable body spectrum measuring apparatus according to a sixth embodiment of the present invention will be described below with reference to FIG. 24. In the sixth embodiment, the multi-spectrum sensor is used as the spectrum sensor S. The sensor controller 140 is used as the feature value varying device, and the sensor controller 140 controls the spectral characteristic varying part that is provided in the spectrum sensor S and can vary the imaging spectral characteristic. FIG. 24 shows schematic configuration of a spectral characteristic varying part 210 used herein.

That is, as shown in FIG. 24, in the spectral characteristic varying part 210 configured as a part of the multi-spectrum sensor, first, the observation light L1 from the measuring object is captured through a lens 211. Then, the captured observation light L1 is spread by a mirror 212 and then, images are formed on the imaging elements 214A to 214C through optical filters 213A to 213C having different wavelength characteristics and transmittances in the spectral characteristic varying part 210. By synthesizing the images of the observation light on the imaging elements 214A to 214C, the imaging spectral characteristic is adjusted according to the wavelength characteristics and the transmittances of the optical filters 213A to 213C.

The spectral characteristic varying part 210 with such a configuration can adjust the imaging spectral characteristic according to the wavelength characteristics and transmittances of the optical filters 213A to 213C, that is, adjust the feature value of the observation light L1.

As described above, the movable body spectrum measuring apparatus according to the sixth embodiment can obtain the following advantages.

(10) The spectral characteristic varying part 210 that can vary the feature value of the observation light is configured of the optical filters 213A to 213C having different wavelength characteristics and transmittances, and the spectrum data regarding the measuring object is acquired by synthesizing the observation light captured into the imaging elements 214A to 214C through the optical filters 213A to 213C. Thereby, the feature value of the observation light detected from the measuring object can be adjusted so as to reduce influence of the ambient light.

(11) The illumination controller 110 and the illumination device 120 in FIG. 1 can be omitted. However, by concurrently using the configuration of any of the first to fourth embodiments with the illumination controller 110 and the illumination device 120, the advantages (1) to (6) in these embodiments can be also obtained.

### Seventh Embodiment

A movable body spectrum measuring apparatus according to a seventh embodiment of the present invention will be described below with reference to FIG. 25. In the seventh embodiment, a filter varying plate 215 in place of the optical filters 213A to 213C configuring the spectral characteristic varying part in the sixth embodiment is provided at each imaging element of the multi-spectrum sensor, and its basic configuration is common to that in the sixth embodiment.

FIG. 25, which corresponds to FIG. 24, shows a spectral characteristic varying part 220 configuring the movable body spectrum measuring apparatus according to the seventh embodiment. The same constituents in FIG. 25 as those in FIG. 24 are given the same reference numerals and overlapping description thereof is omitted.

That is, as shown in FIG. 25, in the spectral characteristic varying part 220, the filter varying plate 215 including a plurality of optical filters 215A to 215H having different wavelength characteristics and transmittances is provided at each of the imaging elements 214A to 214C configuring the multi-spectrum sensor. In detecting the observation light L1, by selectively using the optical filters 215A to 215H of the filter varying plate 215 for each of the imaging elements 214A to 214C, the imaging spectral characteristic can be adjusted according to the wavelength characteristics and transmittances of the optical filters 215A to 215H, and the feature value of the observation light L1 can be adjusted.

As described above, the movable body spectrum measuring apparatus according to the seventh embodiment can obtain advantages similar to the advantages (10) and (11) obtained in the sixth embodiment as well as the following advantage.

(12) The spectral characteristic varying part 220 that can vary the feature value of the observation light is configured of the filter varying plate 215 including the optical filters 215A to 215H having different wavelength characteristics and transmittances. The spectrum data regarding the measuring object is acquired by synthesizing the images of the observation light formed on the imaging elements 214A to 214C through the selectively used optical filters 215A to 215H. As a result, the feature value of the observation light can be adjusted with a higher degree of flexibility and therefore, the measuring object can be discriminated with higher accuracy.

### Eighth Embodiment

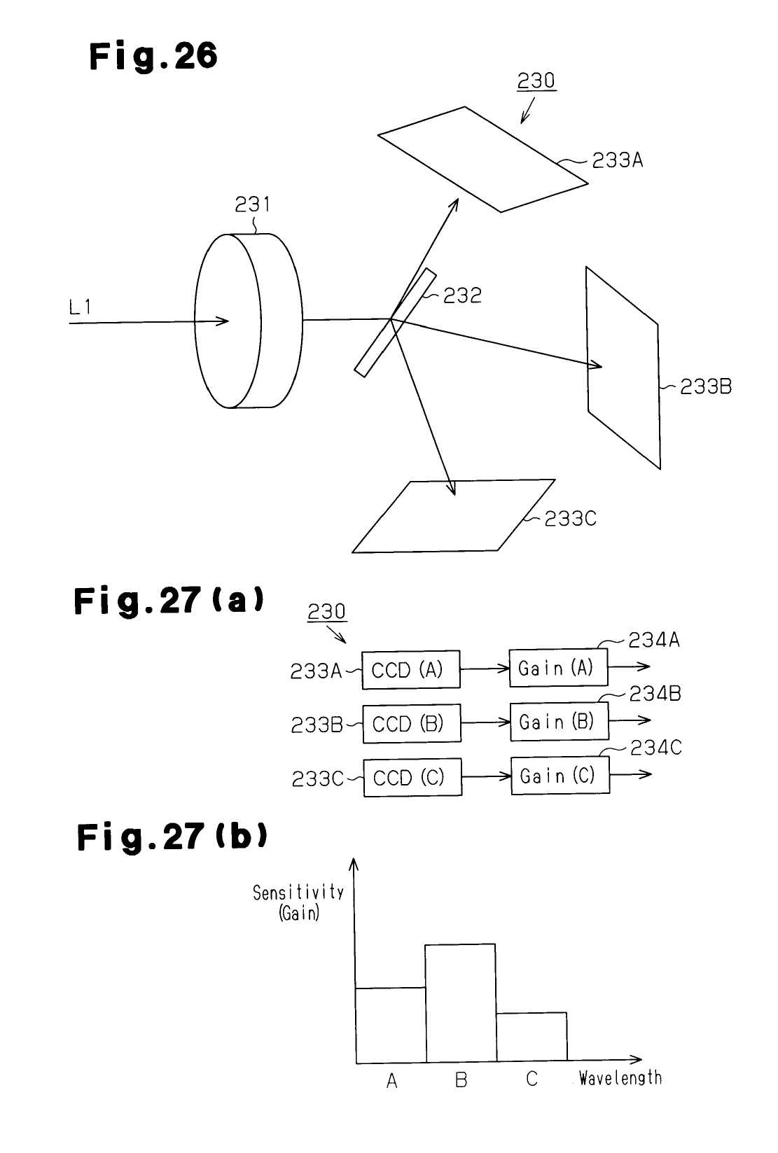

A movable body spectrum measuring apparatus according to an eighth embodiment of the present invention will be described below with reference to FIGS. 26 and 27. Also in the eighth embodiment, the multi-spectrum sensor is used as the spectrum sensor S. The sensor controller 140 is used as the feature value varying device, and the sensor controller 140 controls the spectral characteristic varying part that is provided in the spectrum sensor S and can vary the imaging spectral characteristic. FIG. 26 shows schematic configuration of a spectral characteristic varying part 230 used herein.

That is, as shown in FIG. 26, in the spectral characteristic varying part 230 configured as a part of the multi-spectrum sensor, first, the observation light L1 from the measuring object is captured through a lens 231. Then, the captured observation light L1 is spread by a mirror 232 and then, is captured into the imaging elements 233A to 233C each configured of, for example, a CCD image sensor having a driver as the spectral characteristic varying part 230.

When the observation light L1 is captured into the imaging elements 233A to 233C, as shown in FIG. 27(a), drivers 234A to 234C each adjust a gain for each of the imaging elements 233A to 233C. Through such gain adjustment, as shown in FIG. 27(b), the wavelength range and the light intensity at each wavelength of the observation light L1 are adjusted according to the sensitivity characteristic (gain) of each of the imaging elements 233A to 233C.

The spectral characteristic varying part 230 with such a configuration can adjust the gain (sensitivity) in each wavelength range of the observation light captured into each of the imaging elements 233A to 233C, and thus, can adjust the feature value of the observation light.

As described above, the movable body spectrum measuring apparatus according to the eighth embodiment can obtain the following advantages.

(13) The spectral characteristic varying part 230 that can vary the feature value of the observation light is configured to include the drivers for the imaging elements 233A to 233C, and acquires the spectrum data regarding the measuring object by synthesizing the observation light captured into the imaging elements 233A to 233C. Thereby, the feature value of the observation light, which is detected from the measuring object, can be adjusted in the mode to reduce influence of the ambient light.

(14) The illumination controller 110 and the illumination device 120 in FIG. 1 can be omitted. However, by concurrently using the configuration of any of the first to fourth embodiments with the illumination controller 110 and the illumination device 120, the advantages (1) to (6) obtained in these embodiments can be also obtained.

### Ninth Embodiment

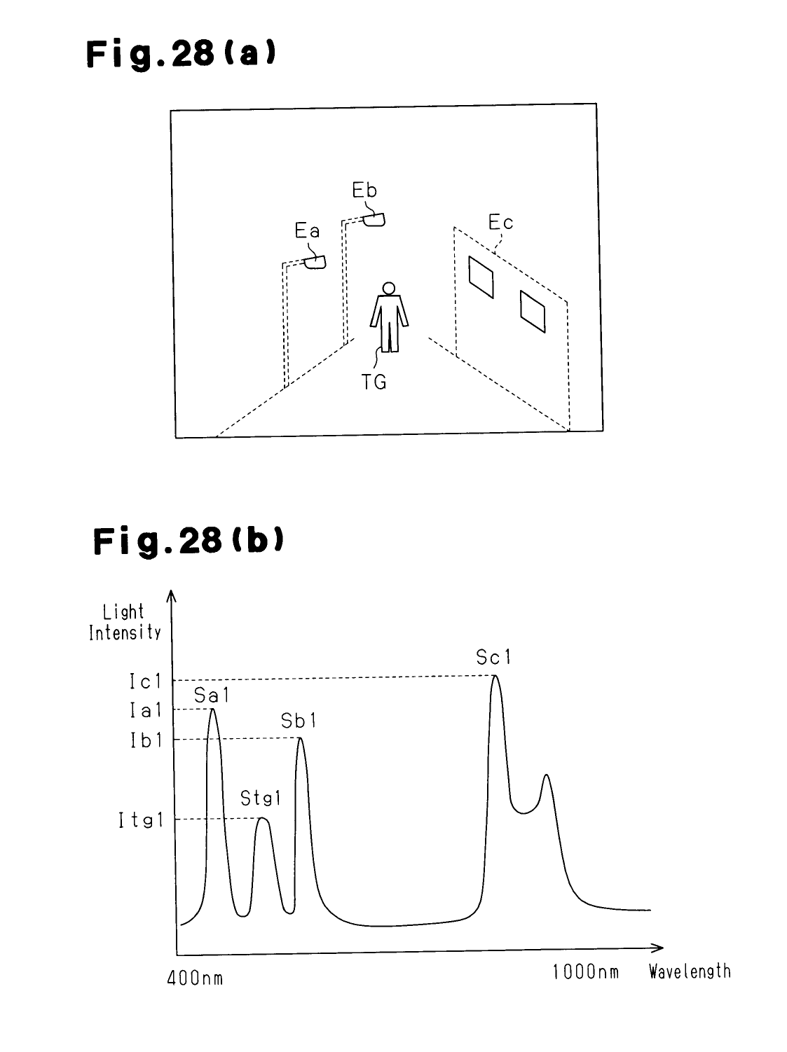

A movable body spectrum measuring apparatus according to a ninth embodiment of the present invention will be described below with reference to FIGS. 28 to 30. In the ninth embodiment, the ambient light is further reduced by controlling blinking of the reference light radiated from the illumination devices 120, 120A to 120C shown in FIG. 1.

FIG. 28(a) shows the influence of ambient light on a measuring object TG in the case where the reference light from the illumination device 120 is turned “off”, and FIG. 28(b) shows an example of the spectrum data detected by the spectrum sensor S at this time.

As shown in FIG. 28(a), in this example, light sources Ea, Eb, Ec exist as external environment elements. The ambient light from the light sources Ea, Eb, Ec is radiated toward a pedestrian TG as the measuring object.

For this reason, the spectrum data detected by the spectrum sensor S at this time includes, as shown in FIG. 28(b), spectrum data Sa1, Sb1, Sc1 of the ambient light from the light sources Ea, Eb, Ec, separately from spectrum data Stg1 of the pedestrian TG as the measuring object. Since the reference light is not radiated toward the pedestrian TG, the spectrum data Stg1 of the pedestrian TG has a small light intensity Itg1 value.

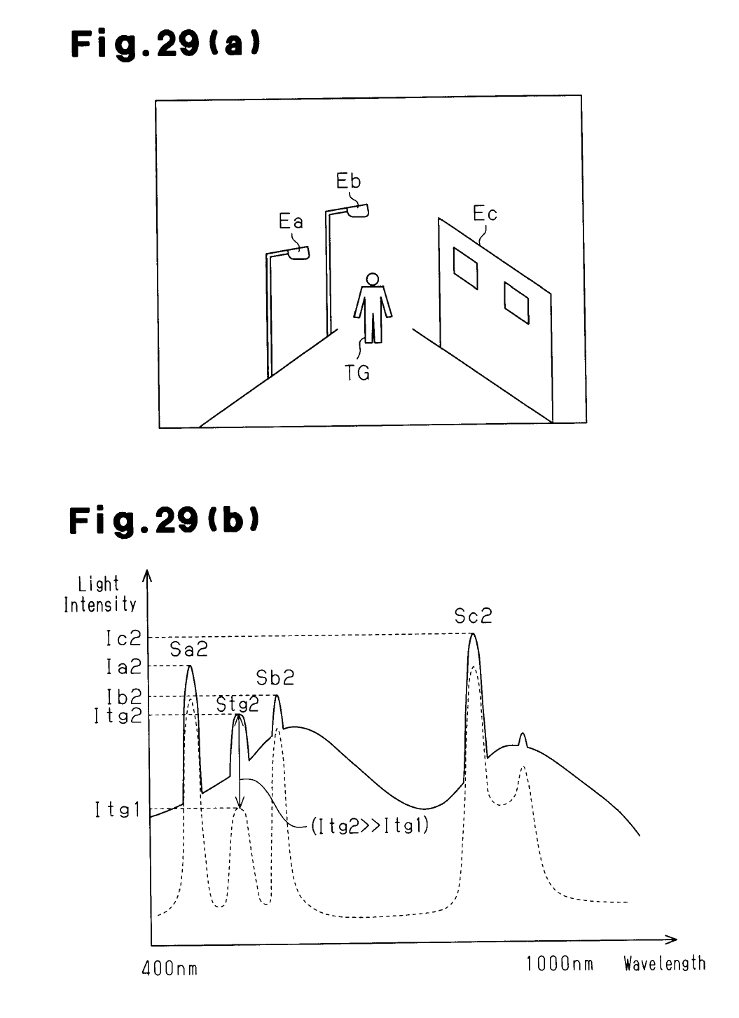

As shown in FIG. 29(a), when the reference light is radiated from the illumination device 120 to the pedestrian TG, as shown in FIG. 29(b) as compared to FIG. 28(b), light intensity Itg2 of spectrum data Stg2 of pedestrian TG is increased by radiation of the reference light (Itg2>>Itg1). Further, light intensities Ia2, Ib2, Ic2 of the spectrum data Sa2, Sb2, Sc2 of the ambient light from the light sources Ea, Eb, Ec, which is detected at this time, are slightly larger than light intensities Ia1, Ib1, Ic1 during non-radiation of the reference light, but the following relationship holds macroscopically: “Ia2≈Ia1, Ib2≈Ib1, Ic2≈Ic1”. That is, the feature value of the spectrum data regarding the ambient light varies insignificantly between during radiation and non-radiation of the reference light, while only the feature value of the spectrum data regarding the pedestrian TG as the measuring object varies.

Then, in this embodiment, the ambient light radiated from the illumination device 120 is controlled to blink, and influence of the ambient light is eliminated through computation of the spectrum data detected during radiation of the reference light and the spectrum data detected during non-radiation of the reference light by the detector 150. The information path indicating “during radiation/non-radiation” of the reference light, which is supplied from the illumination controller 110 to the detector 150, is represented by the broken line arrow in FIG. 1.

First, given that the spectrum data detected by the spectrum sensor S during non-radiation of the reference light is A(λ) and the spectrum data detected by the spectrum sensor S during radiation of the reference light is B(λ), the spectrum data regarding the measuring object TG(λ) is calculated according to the following equation (1).

TG(λ)=B(λ)−A(λ) (1)

When the spectrum data regarding the measuring object TG(λ) is calculated according to the equation (1) in this manner, reflectance Rtg of the measuring object TG is calculated based on TG(λ) and a spectrum D(λ) of the reference light radiated from the illumination device 120 according to the following equation (2).

Rtg=TG(λ)/D(λ) (2)

When the reflectance Rtg of the measuring object TG is calculated according to the equation (2) in this manner, the measuring object is discriminated on the basis of the reflectance Rtg.

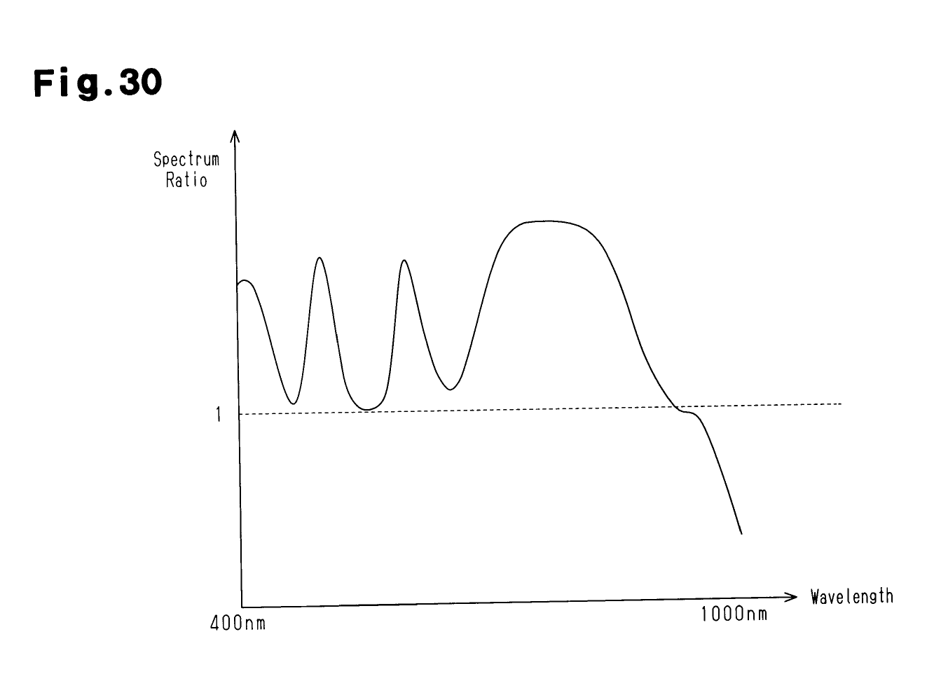

As shown in FIG. 30, the spectrum ratio (B(λ)/A(λ)) of the spectrum data A(λ) during non-radiation of the reference light to the spectrum data B(λ) during radiation of the reference light becomes approximate to “1” when the ambient light is highly identical to the reference light. When the spectrum ratio is smaller than “1”, spectrum change caused by the ambient light occurs. When the spectrum ratio is larger than “1”, spectrum change caused by the reference light occurs.

For this reason, the spectrum change by only radiation of the reference light can be determined based on the ratio of the spectrum data A(λ) during non-radiation of the reference light to the spectrum data B(λ) during radiation of the reference light. Therefore, the measuring object can be discriminated without being influenced by the ambient light.

In this embodiment, control of blinking of the reference light by the illumination device 120 is performed in a cycle of “100 msec” as the computation cycle of the drive assistance system 160 for the vehicle or smaller. As a result, even when the source of the ambient light varies with movement of the vehicle, the measuring object can be discriminated in real time without being influenced by the ambient light at each time.

Also in this embodiment, the first to fourth embodiments, or the fifth to eighth embodiments combined with any one of the first to fourth embodiments can be used concurrently, and through such concurrent use, the measuring object can be performed with higher reliability.

As described above, the movable body spectrum measuring apparatus according to the ninth embodiment can obtain the following advantages.

(15) The reference light radiated from the illumination device 120 is controlled to blink, and the measuring object is discriminated on the basis of the difference or the ratio between the spectrum data during radiation of the reference light and the spectrum data during non-radiation of the reference light. Thus, the measuring object can be discriminated on the basis of the spectrum data without being influenced by the ambient light with higher reliability.

(16) The blinking cycle of the reference light radiated from the illumination device 120 is set to “100 msec” as the computation cycle of the drive assistance system 160 or smaller. Thereby, in mounting the spectrum measuring apparatus on the vehicle, the measuring object can be discriminated with high accuracy and in real time.

### Tenth Embodiment

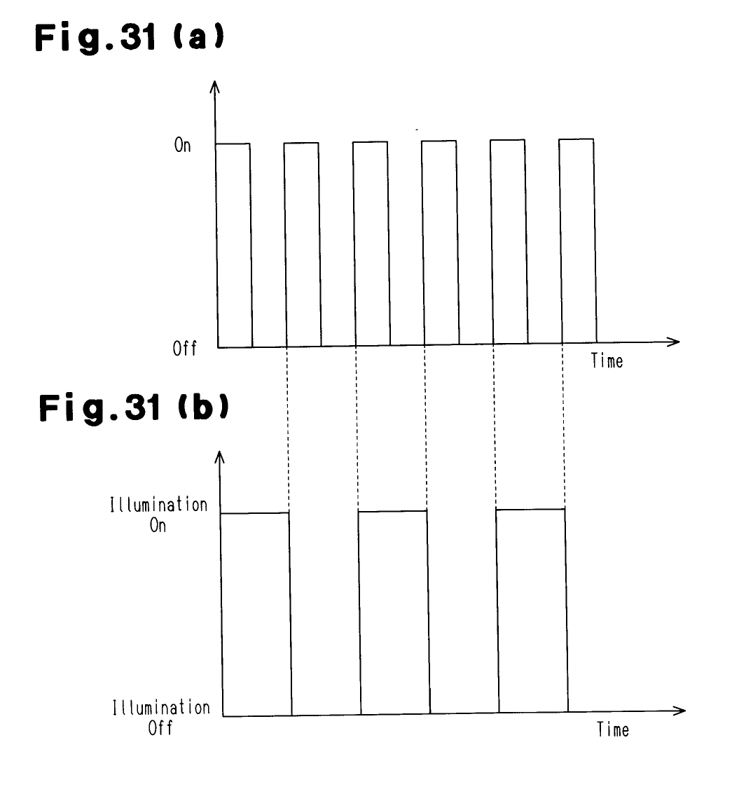

A movable body spectrum measuring apparatus according to a tenth embodiment of the present invention will be described with reference to FIG. 31. In the tenth embodiment, by synchronizing the blinking cycle of the reference light in the ninth embodiment with the AC frequency of the commercial AC power source, influence of the ambient light can be eliminated more reliably.

Generally, an electric lamp such as a street lamp as a source of the ambient light for the vehicle especially in night is lit by power supplied from a commercial AC power source. Such an electric lamp is, as shown in FIG. 31(a), blinked on and off at a cycle using the AC frequency of the commercial AC power source as a reference, that is, at a cycle of “100 Hz standard” in Kanto and “120 Hz standard” in Kansai in Japan. For this reason, even when blinking of the reference light radiated from the illumination device 120 is controlled, it is hard to eliminate the influence from the ambient light in the case where timing of radiation of the reference light deviates from the blinking cycle of the electric lamp or the like.

Thus, in this embodiment, as shown in FIG. 31(b), the blinking cycle of the reference light radiated from the illumination device 120 is synchronized with the blinking cycle of the electric lamp as the source of the ambient light, and the exposure time for the reference light is set to the blinking cycle of the electric lamp or larger. Thereby, during radiation/non-radiation of the reference light, the electric lamp emits light, that is, the ambient light exists, and the spectrum data during radiation of the reference light and the spectrum data during non-radiation of the reference light can be reliably acquired. As a result, in eliminating influence of the ambient light on the basis of the difference or the ratio between the spectrum data during radiation of the reference light and the spectrum data during non-radiation of the reference light, reliability is further improved.

Also in this embodiment, the first to fourth embodiments, or the fifth to eighth embodiments combined with any one of the first to fourth embodiments can be used concurrently, and through such concurrent use, the discrimination of measuring object can be performed with higher reliability.

As described above, the movable body spectrum measuring apparatus according to the tenth embodiment can obtain the following advantage.

(17) The blinking cycle of the reference light radiated from the illumination device 120 is synchronized with the blinking cycle of the electric lamp such as the street lamp as the source of the ambient light. Thus, in eliminating influence of the ambient light through control of blinking of the reference light, reliability is further improved.

### Eleventh Embodiment

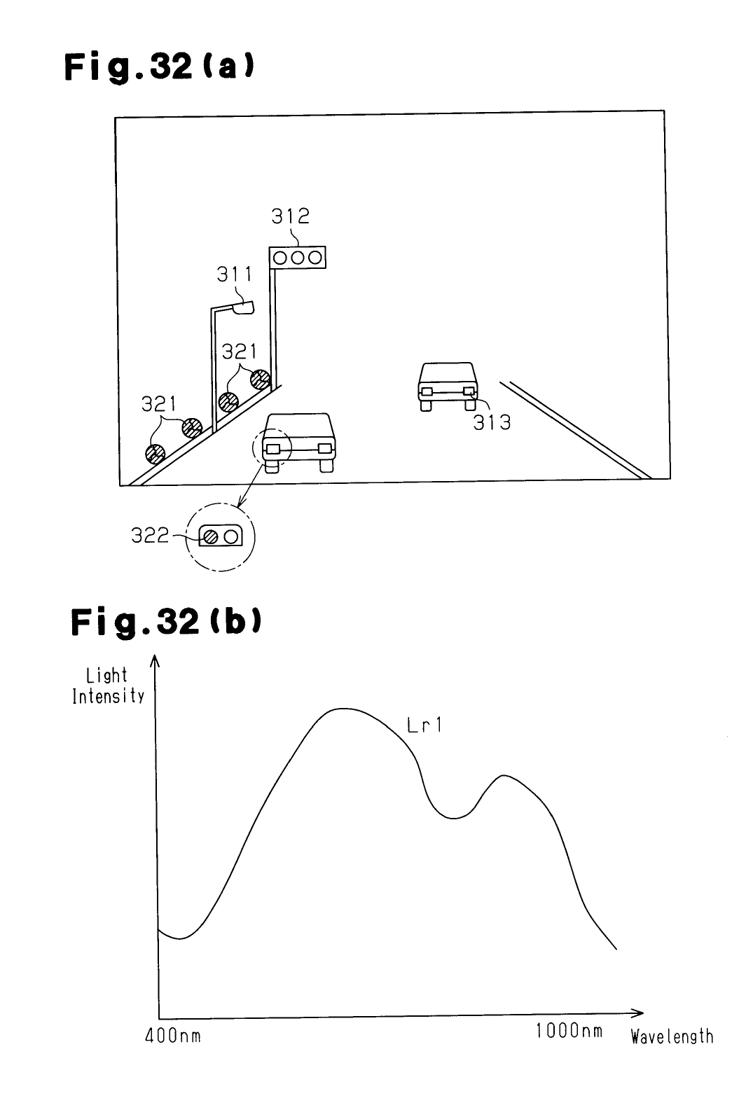

A movable body spectrum measuring apparatus according to an eleventh embodiment of the present invention will be described below with reference to FIGS. 32 to 36. In the eleventh embodiment, it is discriminated whether or not the measuring object is a self-luminous body on the basis of the differential computation between the spectrum data detected during radiation of the reference light and the spectrum data detected during non-radiation of the reference light in the ninth embodiment.

FIG. 32(a) shows influence of the ambient light on the measuring object TG in the case where the reference light by the illumination device 120 is turned “off”, and FIG. 32(b) shows the spectrum data detected by the spectrum sensor S at this time.

First, as shown in FIG. 32(a), it is assumed that, during movement of the vehicle, a self-luminous body such as an electric lamp 311, a traffic light 312 and a tail lamp 313 of the vehicle ahead, and a high reflector such as a reflector 321 provided at an end of a road and a reflector 322 provided in the tail lamp 313 of the vehicle exist as measuring objects.

Given that the reference light is radiated from the illumination device 120 to the measuring object, light radiated from the self-luminous bodies 311 to 313 and reference light reflected from the high reflectors 321 and 322 are detected as the observation light by the spectrum sensor S.

Thus, since the reflectance of the reflector 321 is high, as represented by a curve Lr1 in FIG. 32(b), the light intensity of the spectrum data detected from, for example, the reflector 321 becomes high. For this reason, when the measuring object is discriminated on the basis of only the light intensity in the spectrum data detected by the spectrum sensor S, it is hard to discriminate whether or not the reflectors 321 and 322 are self-luminous bodies.

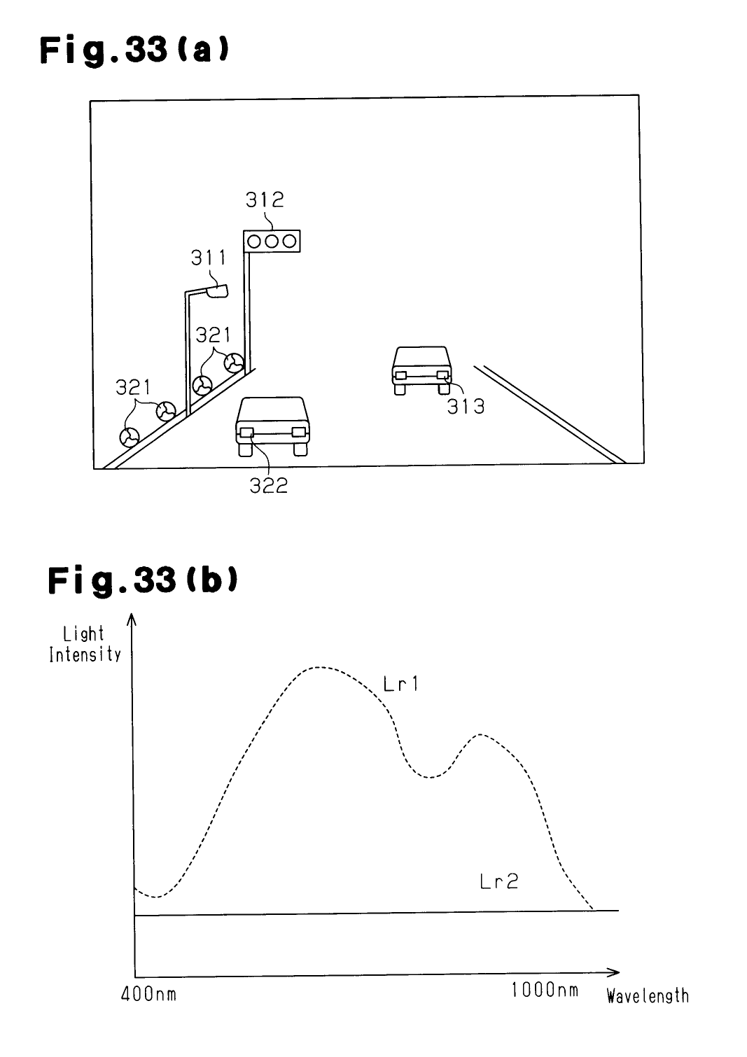

Meanwhile, during non-radiation of the reference light, as shown in FIG. 33(a), only the self-luminous bodies 311 to 313 are light sources and the reflectors 321 and 322 are irradiated with only the ambient light.

For this reason, as represented by a solid line Lr2 indicating the spectrum data regarding the reflector 321 during non-radiation of the reference light and by a broken line Lr1 indicating the spectrum data regarding the reflector 321 during radiation of the reference light in FIG. 33(b), the light intensity lowers when the reference light is not radiated. As a result, a spectrum difference is generated between the spectrum data Lr1 during radiation of the reference light and the spectrum data Lr2 during non-radiation of the reference light.

Thus, in this embodiment, it is discriminated whether or not the measuring object is a self-luminous body on the basis of the difference between the spectrum data during radiation of the reference light and the spectrum data during non-radiation of the reference light. In this embodiment, in an object that absorbs light in the whole wavelength band, in consideration of the characteristic that the difference between the spectrum data during radiation of the reference light and the spectrum data during non-radiation of the reference light is small, the above-mentioned discrimination is performed according to the difference in the spectrum data on the basis of the light intensity of the spectrum data.

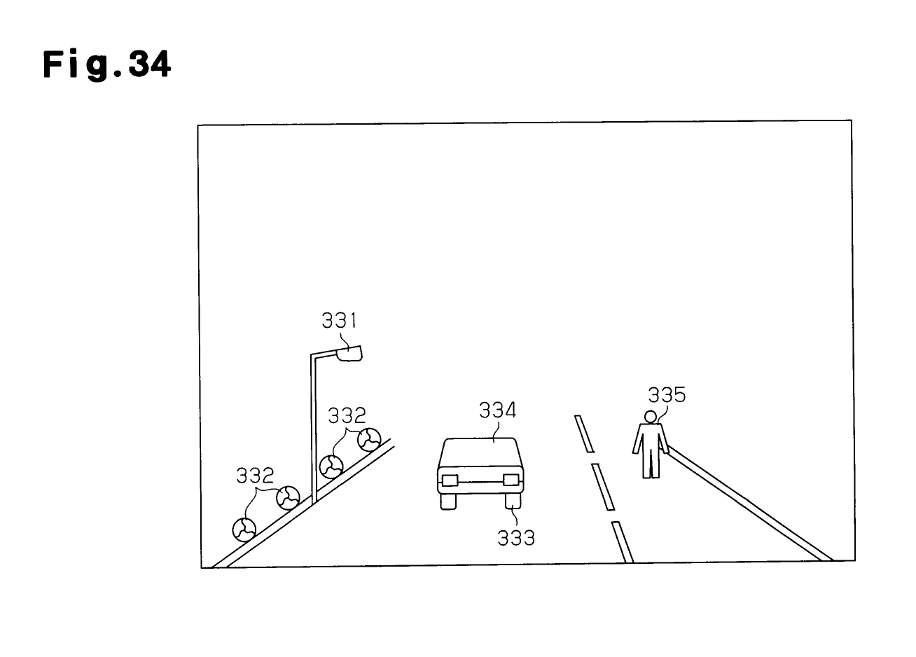

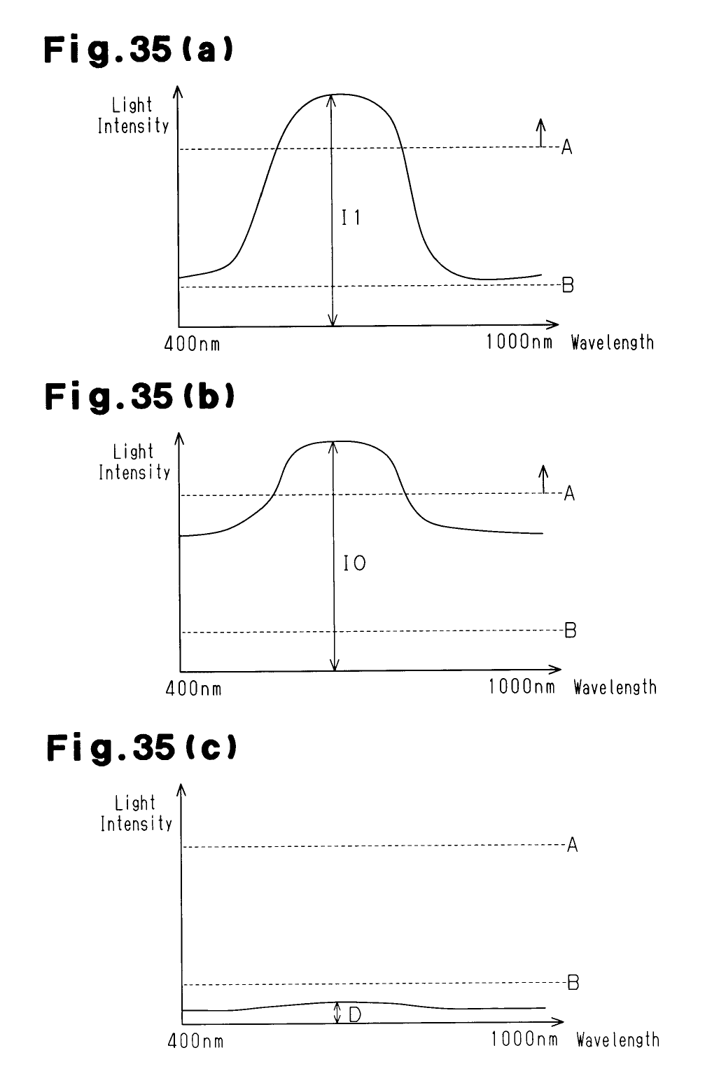

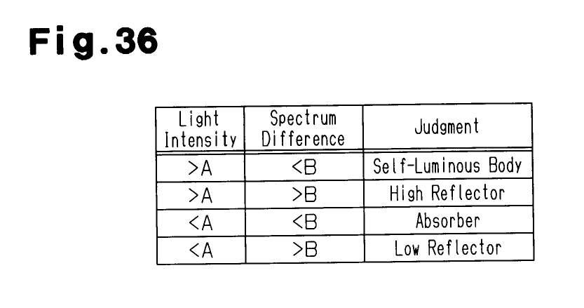

Next, a mode for discriminating whether or not the measuring object is a self-luminous body will be described with reference to FIGS. 34 to 36. FIG. 34 shows an example of the measuring object in accordance with this embodiment. FIG. 35(a) shows the spectrum data regarding the reference light radiated from the illumination device to the measuring object, and FIGS. 35(b) and 35(c) show the spectrum data during radiation of the reference light and the spectrum data during non-radiation of the reference light, respectively, together with the discriminating standard of the measuring object. FIG. 36 shows the determining standard of the measuring object on the basis of the detected spectrum data.

First, as shown in FIG. 34, it is assumed that the electric lamp 331 as a self-luminous body, the reflector 332 as a high reflector, a tire 333 of the vehicle ahead as an absorber and rear glass 334 of the vehicle as a low reflector and a pedestrian 335 exist as the measuring objects.

Given that a reference light having the spectrum shape shown in FIG. 35(a) is radiated toward the measuring object, the spectrum data shown in FIG. 35(b) is detected by the spectrum sensor S. First, it is determined whether or not light intensity 10 of the detected spectrum data exceeds a straight line A indicating a reference for determining whether or not the measuring object is a self-luminous body on the basis of the light intensity.

Further, as shown in FIG. 35(c), it is determined whether or not difference D between the spectrum data during radiation of the reference light and the spectrum data during non-radiation of the reference light with respect to the measuring object exceeds a straight line B for determining whether or not the measuring object is the high reflector on the basis of the spectrum difference.

As a result of determination between the light intensity I0 and the difference D of the detected spectrum data, and the determining standards A and B, when it is determined as

I0>A, D<B,

the measuring object is determined as the “self-luminous body” on the basis of the determining standard shown in FIG. 36.

Further, when the above-mentioned determining result indicates

I0>A, D>B,

the measuring object is determined as the “high reflector” on the basis of the determining standard.

Furthermore, when the above-mentioned determining result indicates

I0<A, D<B,

the measuring object is determined as the “absorber” on the basis of the determining standard.

Finally, when the above-mentioned determining result indicates

I0<A, D>B,

the measuring object is determined as the “low reflector” on the basis of the determining standard.

As described above, the measuring object can be determined as one of a “self-luminous body”, a “high reflector”, an “absorber” or a “low reflector” on the basis of the light intensity I1 in the spectrum data and the spectrum difference D between the spectrum data during radiation of the reference light and the spectrum data during non-radiation of the reference light.

Also in this embodiment, the first to fourth embodiments, or the fifth to eighth embodiments combined with any one of the first to fourth embodiments can be used concurrently, and through such concurrent use, the measuring object can be performed with higher reliability.

As described above, the movable body spectrum measuring apparatus according to the eleventh embodiment can obtain the following advantage.

(8) The measuring object is discriminated on the basis of the light intensity I1 of the spectrum data detected during radiation of the reference light and the difference D between the spectrum data during radiation of the reference light and the spectrum data during non-radiation of the reference light. Thus, the measuring object can be discriminated on the basis of the spectrum data detected by the spectrum sensor S with higher accuracy.

### Twelfth Embodiment

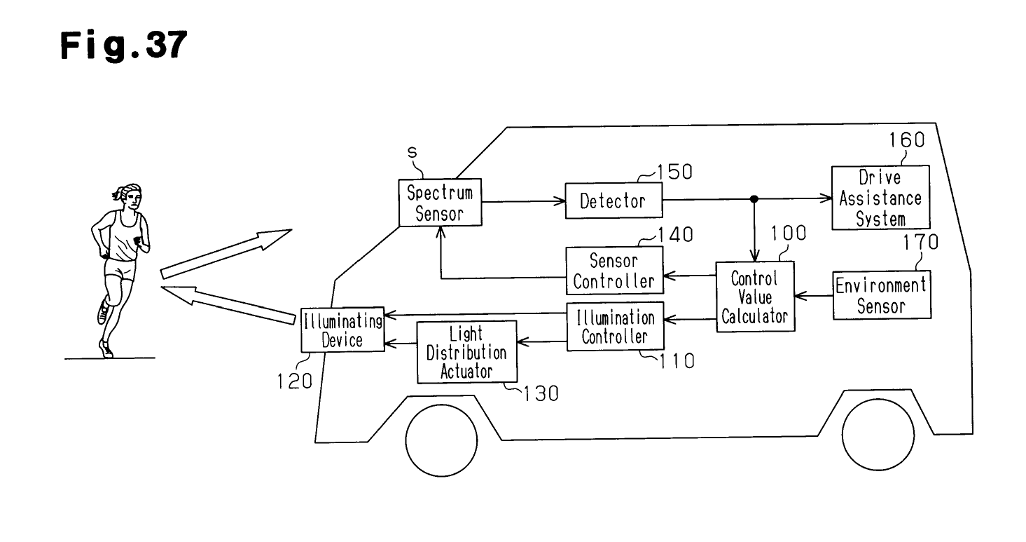

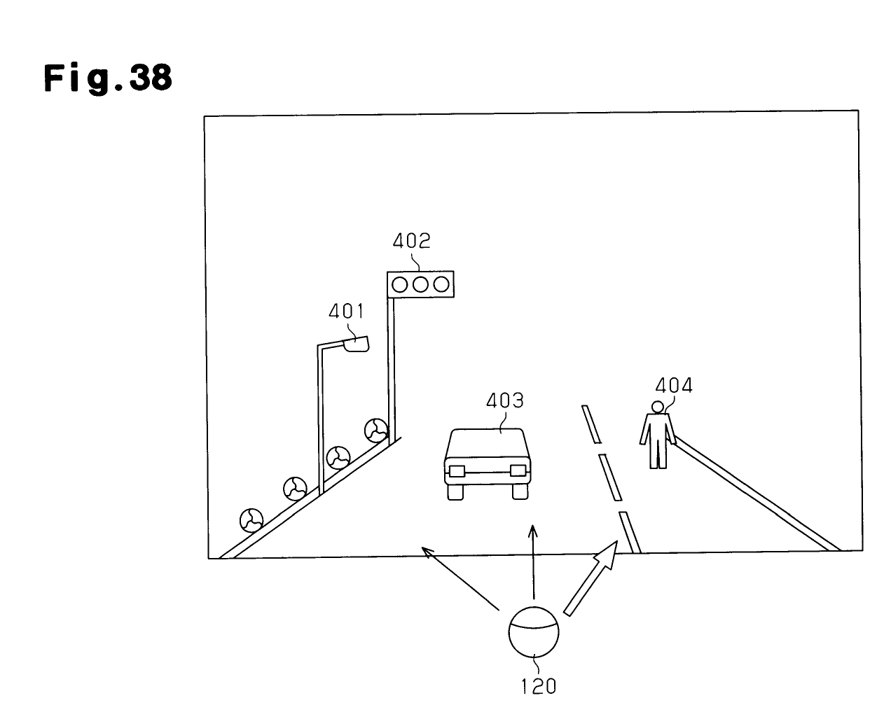

A movable body spectrum measuring apparatus according to a twelfth embodiment of the present invention will be described below with reference to FIGS. 37 and 38. In the twelfth embodiment, distribution of the reference light radiated from the illumination device, that is, the radiation position and intensity distribution is configured to be variable, and its basic configuration is common to that of the first embodiment.

FIG. 37, which corresponds to FIG. 1(a), shows schematic configuration of the movable body spectrum measuring apparatus according to the twelfth embodiment. The same constituents in FIG. 37 as those in FIG. 1(a) are given the same reference numerals and overlapping description thereof is omitted.

That is, as shown in FIG. 37, the movable body spectrum measuring apparatus according to this embodiment includes a light distribution actuator 130 that can vary light distribution as the radiation position of the reference light radiated from the illumination device 120. The control value map of the control value calculator 100 stores the control value for setting distribution of the reference light according to the discriminating information detected by the detector 150 (refer to FIG. 1(b)).

Next, a mode for distributing the reference light performed on the assumption of above-mentioned situation will be described with reference to FIG. 38.

As shown in FIG. 38, given that an electric lamp 401, a traffic signal 402, a vehicle ahead 403 and a pedestrian 404 exist as the measuring objects in front of the vehicle, first, the reference light is radiated from the illumination device 120 to each of the measuring objects. Then, when the spectrum data regarding the measuring objects is detected by the spectrum sensor S, each measuring object is discriminated by the detector 150.

Priority of danger assessment degree for the vehicle is determined based on the discriminating information. For example, when the priority of danger assessment degree of the pedestrian 404 is determined as highest, the illumination controller 110 sets distribution of the reference light radiated from the illumination device 120 so as to lean toward the pedestrian 404 as shown in FIG. 38. Thereby, the reference light is radiated from the illumination device 120 toward the pedestrian 404, resulting in that the spectrum sensor S detects mainly the observation light from the pedestrian 404.

Also in this embodiment, the first to fourth embodiments, or the fifth to eighth embodiments combined with any one of the first to fourth embodiments can be used concurrently, and through such concurrent use, the measuring object can be performed with higher reliability.

As described above, the movable body spectrum measuring apparatus according to the twelfth embodiment can obtain the following advantage.

(19) Distribution of the reference light radiated from the illumination device 120 can be varied according to the discriminated measuring object. Thus, in discriminating the measuring object on the basis of the spectrum data detected by the spectrum sensor S, the measuring object can be discriminated selectively and with higher accuracy.

### Other Embodiments

Each of the above-mentioned embodiments can be implemented as follows.

In the eleventh embodiment, the measuring object is discriminated on the basis of the difference between the spectrum data during radiation of the reference light and the spectrum data during non-radiation of the reference light, and the light intensity in the spectrum data regarding the measuring object detected during radiation of the reference light. The present invention is not limited to this, and when the object that absorbs light in the whole wavelength band can be determined, the measuring object may be discriminated on the basis of only the difference between the spectrum data during radiation of the reference light and the spectrum data during non-radiation of the reference light.

Although the illumination device has a structure that can vary light distribution as the radiation position of the reference light in the twelfth embodiment, such a structure may be omitted when an illumination region necessary for acquiring the spectrum data regarding the measuring object from the reference light radiated from the illumination device can be ensured.

Although the feature value of the observation light is adjusted on the basis of the sunshine degree in the first and fifth embodiments, the feature value of the observation light may be adjusted on the basis of the atmospheric state such as weather detected by the environment information sensor 170, positional information of the vehicle and obstacles, the environment element for the vehicle and the like. Further, the feature value of the observation light may be adjusted according to an instruction of the user.

Although the wavelength range of the reference light radiated from the illumination device is set to “400 nm” to “1000 nm” in the first embodiment, the wavelength range may be any wavelength range that enables discrimination of the measuring object on the basis of the spectrum data acquired by the spectrum sensor. In addition, in acquiring the characteristic spectrum shape from the observation light, it is desired that the wavelength range of the reference light is a visible light region or a near-infrared ray region. Further, when the spectrum sensor is used as a passive sensor for detecting the pedestrian during day and night, it is desired that the wavelength range of the reference light is a far-infrared ray region.

Although the LED light-emitting elements configuring the illumination device 120 are arranged in a matrix in the first embodiment, the LED light-emitting elements may be arranged in any adequate manner, for example, merely in a row. Further, as long as the different LED light-emitting elements having different wavelengths can adjust the wavelength range of the reference light, the wavelength characteristics of the LED light-emitting elements and the arrangement order of the LED light-emitting element are optional.

Although the feature value of the observation light is adjusted by adjusting the wavelength range and the light intensity at each wavelength of the reference light radiated from the illumination device 120 in the first to fourth embodiments, the advantage (1) in the first embodiment can be obtained only by radiating the reference light from the illumination device 120. In this regard, even with the configuration having only the device for radiating the reference light, the feature values of the wavelength range and the light intensity at each wavelength of the observation light, which are detected by the spectrum sensor S, can be varied.

When it is only required that only a certain feature value of the wavelength range and the light intensity at each wavelength of the observation light, which are detected by the spectrum sensor S, can be varied, there is no need to feed the discrimination result of the measuring object and the environment information to the control value calculator 100, and as feed-forward configuration, a configuration having only the control value calculator 100, the illumination controller 110 and the illumination device 120, or configuration having only the control value calculator 100 and the sensor controller 140 may be adopted.

Although a vehicle such as an automobile is assumed as the movable body that mounts the spectrum sensor thereon in each of the above-mentioned embodiments, the movable body may be a two-wheeled motor vehicle, a robot or the like. The present invention is not limited to this, the present invention can be applied as long as the movable body mounts the spectrum sensor thereon and discriminates the measuring object on the basis of the spectrum data detected by the spectrum sensor.

Although the feature values of wavelength range of the observation light and the light intensity at each wavelength are adjusted in each of the above-mentioned embodiments, at least one of the wavelength range of the observation light and the light intensity at each wavelength may be adjusted.

### DESCRIPTION OF THE REFERENCE NUMERALS

100 . . . Control Value Calculator, 110 . . . Illumination Controller, 120, 120A to 120C . . . Illumination Device, 121 . . . Halogen Lamp, 122 . . . Optical Filter Varying Plate, 122A to 122H . . . Optical Filter, 123 . . . Spectroscope, 124 . . . Phase Plate, 125 . . . Lens, 126 . . . Slit, 127 . . . Parallel Lens, 128, 128A to 128D . . . Shielding Plate, 128Up, 128Do . . . Plate Member, 130 . . . Light Distribution Actuator, 140 . . . Sensor Controller, 150 . . . Detector, 160 . . . Drive Assistance System, 170 . . . Environment Information Sensor, 200 . . . Spectral Characteristic Varying Part, 201 . . . Slit, 202 . . . Spectroscope, 203 . . . CMOS Image Sensor, 210 . . . Spectral Characteristic Varying Part, 211 . . . Lens, 212 . . . Mirror, 213A to 213C . . . Optical Filter, 214A to 214C . . . Imaging Element, 215 . . . Filter Varying Plate, 215A to 215H . . . Optical Filter, 220, 230 . . . Spectral Characteristic Varying Part, 231 . . . Lens, 232 . . . Mirror, 233A . . . Imaging Element, 233A to 233C . . . Imaging Element, 311 . . . Electric Lamp, 312 . . . Traffic Lamp, 313 . . . Tail Lamp, 321 . . . High Reflector, 321, 322 . . . Reflector, 331 . . . Electric Lamp, 332 . . . Reflector, 333 . . . Tire, 334 . . . Rear Glass, 335 . . . Pedestrian, 401 . . . Electric Lamp, 402 . . . Traffic Lamp, 403 . . . Vehicle Ahead, 404 . . . Pedestrian, Ea, Eb, Ec . . . Light Source, TG . . . Pedestrian (Measuring Object), S . . . Spectrum Sensor.

1. A movable body spectrum measuring apparatus provided with a spectrum sensor mounted on a movable body, the spectrum sensor being capable of measuring wavelength information and light intensity information, the spectrum measuring apparatus discriminating a measuring object around the movable body on the basis of spectrum data regarding observation light detected by the spectrum sensor, and the apparatus comprising:
a feature value varying device for varying a feature value of a wavelength range of the observation light and a light intensity at each wavelength of the observation light; and
a controller for controlling a feature value varying mode of the feature value varying device regarding the wavelength range on the basis of a control value corresponding to an environment element.

2. The movable body spectrum measuring apparatus according to claim 1, wherein
an illumination device is provided as the feature value varying device, the illumination device radiating reference light, at least one of the wavelength range and the light intensity at each wavelength of the reference light being changeable, and
the controller controls at least one of the wavelength range and the light intensity at each wavelength of the reference light radiated from the illumination device on the basis of the control value, thereby varying the feature value of the observation light.

3. The movable body spectrum measuring apparatus according to claim 2, wherein the controller is configured to be capable of controlling blinking of reference light radiated from the illumination device.

4. The movable body spectrum measuring apparatus according to claim 1, wherein
an illumination device is provided as the feature value varying device, the illumination device radiating reference light toward the measuring object, and
the controller controls blinking of the reference light radiated from the illumination device on the basis of the control value, thereby varying the feature value of the observation light.

5. The movable body spectrum measuring apparatus according to claim 3, wherein the measuring object is discriminated by computing the spectrum data during radiation of the reference light and the spectrum data during non-radiation of the reference light on the basis of control of blinking of the reference light by the controller.

6. The movable body spectrum measuring apparatus according to claim 5, wherein in computing the two pieces of spectrum data regarding the observation light, the difference or the ratio between the pieces of spectrum data is acquired.

7. The movable body spectrum measuring apparatus according to claim 5, wherein the discrimination of the measuring object is discrimination on whether or not the measuring object is a self-luminous body on the basis of a differential computation between the pieces of the spectrum data regarding the observation light.

8. The movable body spectrum measuring apparatus according to claim 3, wherein
ambient light of the measuring object is light from an electric lamp lit with power supplied from a commercial AC power source, and
a blinking cycle of the blinking control of the reference light by the controller is set so as to be in sync with a cycle using an AC frequency of the commercial AC power source as a reference.

9. The movable body spectrum measuring apparatus according to claim 3, wherein
the movable body is provided with a drive assistance system for periodically computing various information supporting driving of the movable body, and
a blinking cycle of the blinking control of the reference light by the controller is set so as to be equal to or smaller than a computation cycle of the drive assistance system.

10. The movable body spectrum measuring apparatus according to claim 2, wherein
the illumination device is configured to be capable of changing light distribution, which is a radiation position of the reference light, and
the controller controls light distribution of the reference light by the illumination device according to the discriminated measuring object.

11. The movable body spectrum measuring apparatus according to claim 2, wherein the illumination device uses an LED luminous body as a source of the reference light.

12. The movable body spectrum measuring apparatus according to claim 11, wherein
the LED luminous body includes a plurality of LED light-emitting elements that emit light components having different wavelengths and are arranged in a row or a matrix, and
the controller selectively drives the LED light-emitting elements to control the wavelength range of the reference light, and adjusts the value of a current supplied to the selected LED light-emitting element or the duty cycle of a pulse voltage applied to the selected LED light-emitting element to control the light intensity at each wavelength of the reference light or to control blinking.

13. The movable body spectrum measuring apparatus according to claim 2, wherein the illumination device uses a halogen lamp as a source for the reference light.

14. The movable body spectrum measuring apparatus according to claim 13, wherein
the illumination device includes a plurality of optical filters having different wavelength characteristics and transmittances, which cover the halogen lamp, and
through selection of the optical filters, the controller controls at least one of the wavelength range and the light intensity at each wavelength of the reference light or controls blinking.

15. The movable body spectrum measuring apparatus according to claim 13, wherein
the illumination device is provided with a spectroscope for separating light radiated from the halogen lamp according to wavelength, and
through adjustment of the phase of the light separated according to wavelength, the controller controls at least one of the wavelength range and the light intensity at each wavelength of the reference light or controls blinking.

16. The movable body spectrum measuring apparatus according to claim 13, wherein
the illumination device is provided with a spectroscope for separating light radiated from the halogen lamp according to wavelength, and
through selective transmission or restriction of the light separated according to wavelength, the controller controls at least one of the wavelength range and the light intensity at each wavelength of the reference light or controls blinking.

17. The movable body spectrum measuring apparatus according to claim 2, wherein the reference light radiated from the illumination device is light having wavelength in a nonvisible region.

18. The movable body spectrum measuring apparatus according to claim 1, wherein
the feature value varying device includes a spectral characteristic varying part for varying an imaging spectral characteristic of the mounted spectrum sensor, and
the controller controls the imaging spectral characteristic by the spectral characteristic varying part on the basis of the control value, thereby varying the feature value of the observation light.

19. The movable body spectrum measuring apparatus according to claim 18, wherein
the mounted spectrum sensor is a spectrum sensor provided with a CMOS image sensor as an imaging element,
the feature value varying device includes a pixel driver of the CMOS image sensor as the spectral characteristic varying part, and
the controller controls the imaging spectral characteristic by adjusting gain at each pixel of the CMOS image sensor, which corresponds to each light separated according to wavelength, thereby varying the feature value of the observation light.

20. The movable body spectrum measuring apparatus according to claim 18, wherein
the mounted spectrum sensor is a multi-spectrum sensor for capturing the observation light into each of a plurality of imaging elements through optical filters having different wavelength characteristics and transmittances,
the feature value varying device includes the optical filters having different wavelength characteristics and transmittances as the spectral characteristic varying part, and
the controller controls the imaging spectral characteristic by synthesizing the observation light captured into each of the imaging element through the optical filters, thereby varying the feature value of the observation light.

21. The movable body spectrum measuring apparatus according to claim 18, wherein
the mounted spectrum sensor is a multi-spectrum sensor for directing the observation light to each of a plurality of imaging elements having different wavelength ranges,
the feature value varying device includes a driver for each of the imaging elements as the spectral characteristic varying part, and
the controller controls the imaging spectral characteristic by adjusting a gain of each of the imaging elements, thereby varying the feature value of the observation light.

22. The movable body spectrum measuring apparatus according to claim 1, wherein the controller determines the control value corresponding to the environment element on the basis of a detection result of the spectrum sensor.

23. The movable body spectrum measuring apparatus according to claim 1, wherein
the movable body is further provided with an environment information sensor for detecting surrounding environment information of the movable body, and
the controller determines the control value corresponding to the environment element on the basis of a detection result of the environment information sensor.

24. The movable body spectrum measuring apparatus according to claim 23, wherein the environment information sensor is an image sensor for acquiring a surrounding image of the movable body.

25. The movable body spectrum measuring apparatus according to claim 23, wherein the environment information sensor is a radar device for detecting presence or absence of an object in the surroundings of the movable body and the distance from the object on the basis of a reception mode of a reflected wave of a transmitted radio wave.

26. The movable body spectrum measuring apparatus according to claim 1, wherein the movable body is an automobile moving on a road surface.
